(19) United States
(12) Patent Application Publication
(10) Pub. No.: US 2011/0014342 A1
(43) Pub. Date: Jan. 20, 2011

(54) BABY FOOD MAKER

(75) Inventors: Augusto A. Picozza, Boca Raton, FL (US); Patrick J. Curran, Pompano Beach, FL (US); Joseph C. Spencer, JR., Purvis, MS (US)

Correspondence Address: HOFFMANN & BARON, LLP, 6900 JERICHO TURNPIKE, SYOSSET, NY, 11791, US

(73) Assignee: SUNBEAM PRODUCTS, INC., Boca Raton, FL (US)

(21) Appl. No.: 12/842,202

(22) Filed: Jul. 23, 2010

Related U.S. Application Data
(63) Continuation-in-part of application No. 12/620,382, filed on Nov. 17, 2009.
Application No. 12/620,382 is a continuation of application No. 11/510,014, filed on Aug. 25, 2006, now Pat. No. 7,617,766.

(51) Int. Cl. A47J 27/04; A47J 36/00; A23L 1/01

(52) U.S. Cl. 426/474; 99/339; 99/410

(57) ABSTRACT

An apparatus and method are provided for steaming and blending food products such as baby food. The apparatus includes a base including a steam chamber and a drive shaft. A container assembly can be mounted to the base in an inverted position for steaming the food and in an upright position for blending the food. The apparatus may further include a steam cooker, baby bottle sterilizing unit and a bottle warmer.

### CROSS-REFERENCE TO RELATED APPLICATIONS

This patent application is continuation-in-part of U.S. patent application Ser. No. 12/620,382 filed on Nov. 17, 2009, which is a continuation application of U.S. patent application Ser. No. 11/510,014, filed on Aug. 25, 2006 and issued as U.S. Pat. No. 7,617,766, both of these applications are incorporated by reference herein in their entirety for all purposes.

### BACKGROUND

1. Field of the Invention

The field of the invention relates to methods and assemblies for steaming and blending food products.

2. Brief Description of the Related Art

Various appliances have been designed for steaming and/or blending food products. Baby food is often made by steaming food products and then placing them in a blender. While two separate appliances, namely a steamer and a blender, can be employed for making pureed food such as baby food, some appliances have been designed that provide both such functions. U.S. Pat. Nos. 6,076,452 and 6,550,372 and WO 2005/094648 A1 disclose food processing devices that allow the user to first steam food products and then blend them in the same device.

Appliances have also been designed for sterilizing baby bottles. Some sterilizers intended for this purpose have employed steam. U.S. Pat. Nos. 4,544,529 and 5,213,776 disclose such sterilizing appliances.

Baby bottle warmers are commercially available for warming baby bottles or other vessels containing baby food. WO 03/071910 A1 discloses a food warmer that employs steam to warm a food containing vessel.

### SUMMARY

The present invention is directed to an apparatus and a method for steaming and blending food products.

An assembly for steaming and blending food products is further provided in accordance with the invention.

Also provided is an apparatus for steaming and blending food products, including a base having a support for a container assembly. A steam chamber is supported by the base and including a steam exit port. A heater provides heat to the steam chamber. The container assembly includes a container, a lid removably coupled to a top end portion of the container, and a steam inlet port. The container assembly is mountable to the base in a first orientation wherein the steam inlet port is in communication with the steam exit port. A blade assembly is rotatably disposed within the container and includes an elongate hub having at least one blade extend from the hub. The hub forms a conduit for steam to travel there-through.

Further provided is a food preparation assembly including an apparatus for steaming and blending food products including a base including a support for a container assembly. A steam chamber is supported by the base and includes a steam exit port. A heater provides heat to the steam chamber. An electric motor is supported by the base and is operatively associated with a drive shaft. The container assembly includes a container, a steam inlet passage, and a lid removably coupled to a top end portion of the container. The container assembly is selectively mountable to the base support. A blade assembly is disposed within the container. A stream cooker including a plurality of stackable trays is positionable on the lid of the container in place of the container. The steam cooker being selectively mountable to the base and being in fluid communication with the steam chamber.

A method in accordance with the present invention includes:

providing a base including a steam chamber, a steam exit port in fluid communication with the steam chamber, a drive shaft, and an electric motor for rotating the drive shaft;

providing a container assembly including a container having a bottom end portion and an open top end portion, a lid removably mounted to the top end portion, and a steam inlet passage;

providing a blade assembly disposed within the container;

introducing food into the container;

placing the container on the base in an inverted position such that the steam inlet passage communicates with the steam exit port; and

causing the steam chamber to produce steam wherein the steam enters the container through the steam inlet passage and a portion of the steam travels up through the conduit in the hub and steams the food.

### BRIEF DESCRIPTION OF THE DRAWINGS

FIG. 1 is an exploded, perspective view of a base assembly for a baby food maker in accordance with the invention;

FIG. 2. is a sectional view thereof;

FIG. 3. is a bottom view thereof with the bottom cover removed;

FIG. 4 is an exploded, perspective view of a container assembly and associated components for use with the base assembly;

FIG. 5 is a sectional view showing the container assembly mounted to the base assembly in a first orientation for blending food;

FIG. 6. is a sectional view showing the container assembly mounted to the base assembly in a second, inverted orientation for steam cooking food;

FIG. 7 is a sectional view showing a sterilizing unit mounted to the base assembly;

FIG. 8 is a sectional view showing a bottle warmer mounted to the base assembly;

FIG. 9 is a perspective view of an alternative embodiment of a baby food maker in accordance with the present invention;

FIG. 10 is a cross-sectional view of the baby food maker of FIG. 9;

FIG. 11 is a cross-sectional view of the base of FIG. 9;

FIG. 12 is an exploded view of the container of FIG. 9;

FIG. 13 is a cross-sectional view of the container of FIG. 12;

FIG. 14 is a cross-sectional view of the baby food maker of FIG. 9 showing the container in a steaming position;

FIG. 14A is a perspective view of the baby food maker showing the container in an inverted position.

FIG. 15 is a perspective view of the baby food maker of FIG. 9 with a sterilizing unit attached thereto;

FIG. 16 is a cross-sectional view of the baby food maker with sterilizing unit;

FIG. 17 is a side elevational view of a steam chamber cover of the present invention.

FIG. 18 is perspective view of a further alternative embodiment of the baby food maker in accordance with the present invention;

FIG. 19 is a cross-sectional view of the baby food maker of FIG. 18;

FIG. 20 is a cross-sectional view of the baby food maker of FIG. 18 showing a container assembly in a steaming position;

FIG. 20A is a perspective view of a condensate collector of the present invention;

FIG. 21 is an exploded perspective view of the container assembly;

FIG. 22 a bottom elevational view of a blade assembly;

FIG. 23 is a top exploded perspective view of the underside of a lid of the container assembly;

FIG. 24 is a partial perspective view of a container with a portion of a handle broken away to show a lid locking mechanism;

FIG. 25 is a top perspective view of the base of the baby food maker;

FIG. 26 is a cross-sectional view of the container assembly;

FIG. 27 is a bottom elevational view of the container assembly showing an actuator in a first position;

FIG. 28 is a bottom elevational view of the container assembly showing an actuator in a second position;

FIG. 29 is a partial top plan view showing the lid engaging a portion of the lockout mechanism;

FIG. 30 is a perspective view showing a steam cooker secured to the base;

FIG. 30A is an exploded view if a stream cooker;

FIG. 31 is a perspective view of the present invention showing a warmer and a sterilizing unit attached to the base;

FIG. 31A is a cross-sectional view showing the sterilizing unit attached to the base

FIG. 32 is an exploded perspective view of the sterilizing unit;

FIG. 33 is a perspective view of the warmer in the base with a baby bottle being inserted therein;

FIG. 33A is an exploded perspective view of the warmer; and

FIG. 34 is an exploded perspective view of a cover for a steam chamber.

### DETAILED DESCRIPTION

The detailed description which follows is directed to a preferred embodiment of the invention, and is not intended as limiting the invention to the specific structures disclosed. The invention should instead be construed in accordance with the claims that are appended.

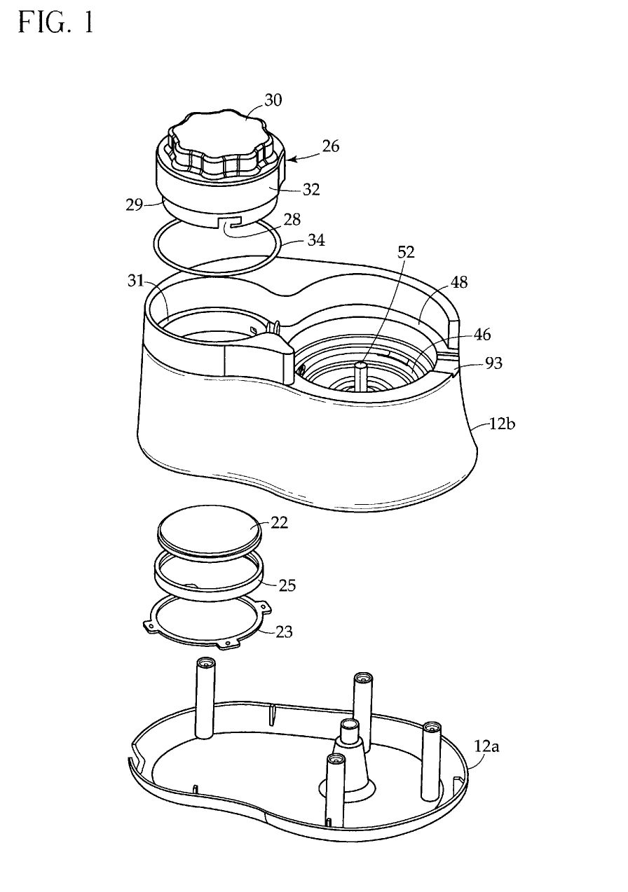

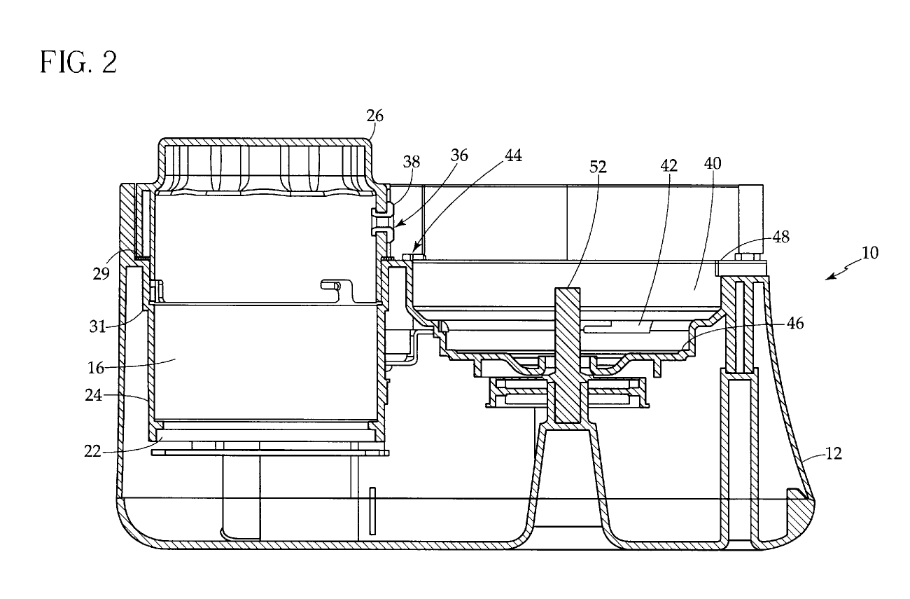

With reference to FIGS. 1 to 4, an apparatus 10 for steaming and blending food products is provided. The apparatus can be used for making baby food or other types of pureed foods. As discussed below, it can also be adapted for sterilizing or warming baby bottles or other food containers. A base 12 is provided for supporting a removable container 14, a steam chamber 16, and a motor 18 for driving a blade assembly 20 or other blending device. Referring specifically to FIGS. 1 and 2, the base 12 defines an enclosure into which the steam chamber 16 extends. The base is comprised of a bottom cover 12a and housing 12b. The steam chamber is defined in part by a vessel 24 having a metal bottom that readily conducts heat. The entire vessel can be formed of plastic or metal. The vessel is preferably permanently secured to the base 12. An electric heater, such as a resistance heater 22, is positioned in close proximity to the vessel. The heater is supported by a bracket 23. A gasket 25 is provided between the heater and bracket. The vessel 24 is substantially cylindrical and has an open top end. The steam chamber further comprises a cover 26 that is removably mounted to the top end of the vessel. A bayonet-type locking mechanism is employed to secure the cover 26, including bayonet-type slots 28 in the cover 26. The cover includes a top wall 30 and a skirt 32 extending downwardly from the top wall. The skirt is indented near the top wall 30 and includes an undulating surface to facilitate application and removal of the cover. The lower portion of the skirt is generally cylindrical, but includes a shoulder 29 that rests upon an annular surface 31 of the base 12. A gasket 34 is positioned between the cover's shoulder 29 and the base to prevent the escape of steam. A steam exit port 36 is provided in the skirt 32. A resilient grommet 38 is secured to the port 36, portions of which extend beyond the skirt walls. These portions secure the grommet in place. The portion of the grommet adjoining the outer surface of the skirt 32 provides a sealing mechanism for an adjoining vessel, as described below. The cover 26 and base are designed such that the steam exit port 36 is oriented in a selected direction when the cover is properly secured.

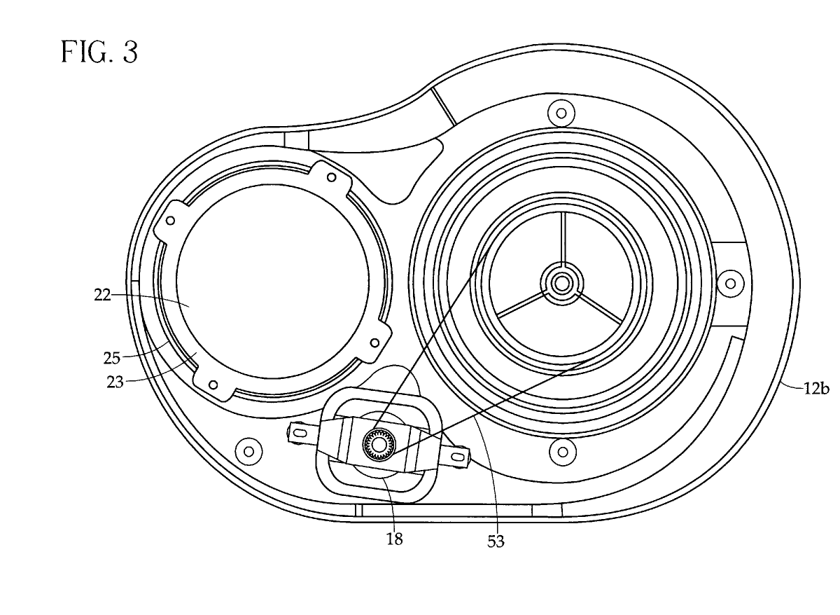

A receptacle 40 for a portion of the container 14 is defined by the base 12 such that the container can be mounted to the base in side by side relation to the steam chamber. A first locking structure 42 in the form of one or more slots is provided at a first elevation in the wall bounding the receptacle 40. A second locking structure 44 is provided at a higher elevation. Both locking structures 42, 44 are designed to interact with complementary locking structures located on the container 14 and container lid 50, respectively. The receptacle 40 includes a plurality of levels or tiers. The bottom tier 46 has a relatively small diameter while the upper tier 48 has a larger diameter. Each tier includes a generally annular horizontal surface. The electric motor 18 is mounted beneath the receptacle 40. A drive shaft 52 is operatively associated with the motor and extends into the receptacle 40. The drive shaft rotates about its longitudinal axis when the motor is actuated. As shown in FIG. 3, the drive shaft is driven by a belt 53 mounted to two pulleys, one associated with the motor output shaft and the other with the drive shaft 52 for the blade assembly 20.

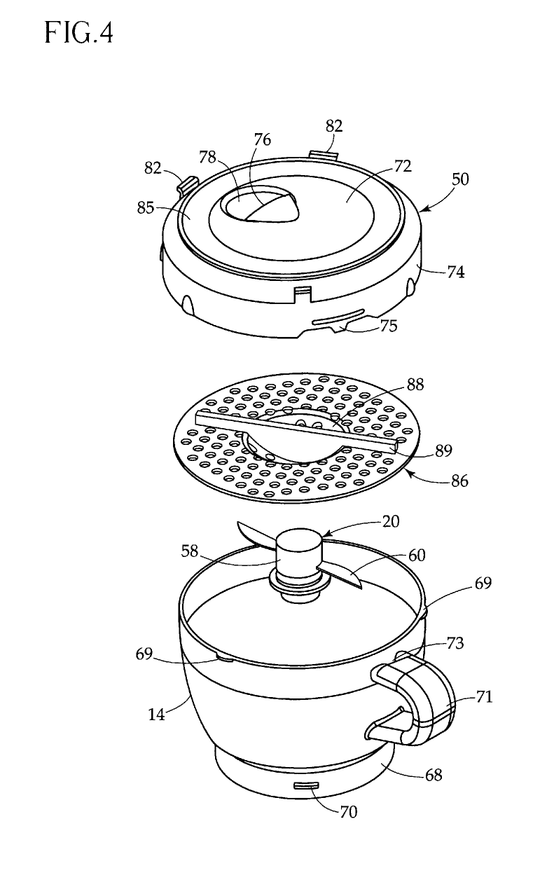

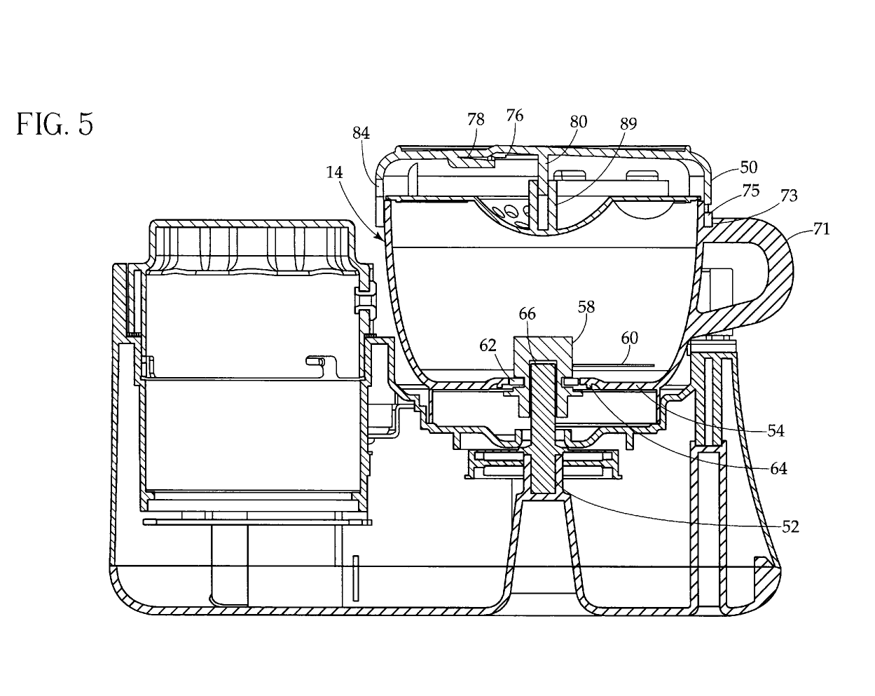

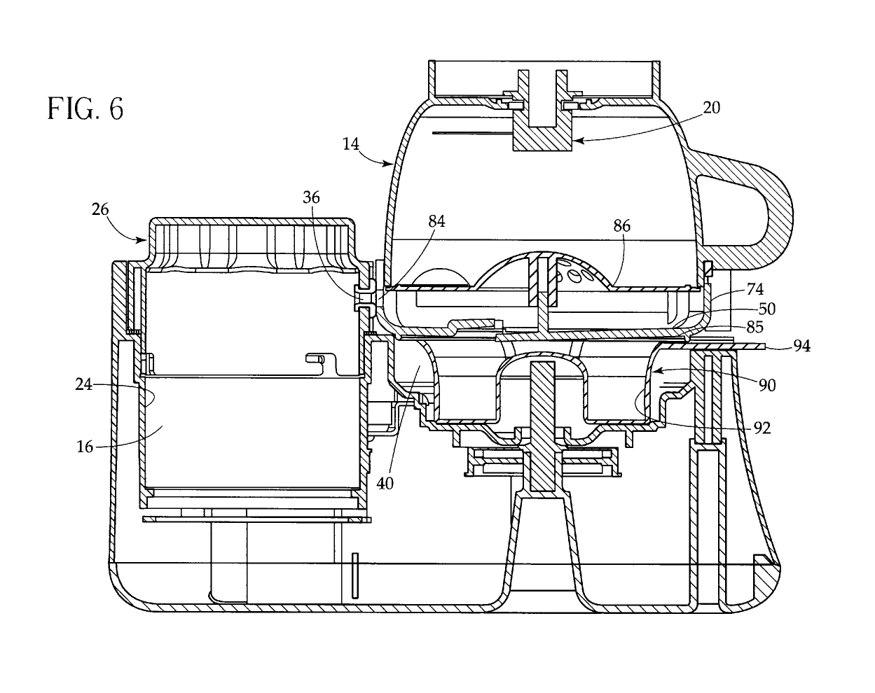

With reference to FIGS. 4 to 6, the container 14 includes a bottom wall 54 having a central opening as shown in FIGS. 5 and 6. The blade assembly 20 is disposed within the container 14. In the embodiment shown in FIGS. 4-6, the blade assembly may be mounted to the bottom wall 54. The blade assembly 20 includes a coupling 58 to which a plurality of blades 60 are mounted. The coupling 58 extends partially below the bottom wall of the container and partially above it. The middle portion of the coupling 58 is slotted for receiving portions of the bottom wall 54 adjoining the central opening. It is removably secured to the bottom wall of the container. An annular seal 62 is provided between a shoulder portion of the coupling and an annular ring 64 extending downwardly from the bottom wall. The coupling includes a central passage 66 configured to receive the drive shaft 52. The passage is defined by a multi-sided wall surface. The drive shaft includes corresponding surfaces whereby the coupling and the blades are caused to rotate upon rotation of the drive shaft.

The container includes an annular base portion 68 extending below the bottom wall 54 as well as beyond the bottom of the coupling 58. A plurality of projections 70 extend radially outwardly from the outer surface of the base portion 68. The projections are positionable within the bayonet-type slots comprising the first locking structure 42 when the container is mounted to the base in a first orientation as shown in FIG. 5. They allow the container to be removably locked to the base 12 by rotating the container once the projections are within the slots. The apparatus 10 can be used for blending when the container is locked in this position. The base portion also allows the container to be placed upon a horizontal surface without danger of tipping over. A handle 71 extends from a side wall of the container. A slot 73 may be formed in the upper wall of the handle 71 to receive a tab 75 depending from the lid. The engagement of the tab 75 in slot 73 helps releasably retain the lid in the closed position. The top end of the container 14 includes three rounded projections 69 that extend radially outwardly, as shown in FIG. 4.

The container lid 50 includes a top wall 72 and a generally cylindrical skirt 74 that is integral with the top wall 72. A slotted opening 76 is formed in the top wall. A ramp 78 formed integrally with the top wall of the lid extends below the opening 76. The top wall is formed so that, when inverted, liquid within the lid will tend to flow towards the slotted opening. A partition wall 80 extends from the bottom surface of the top wall and bisects the interior portion of the lid. A plurality of projections 82 extend radially outwardly from the lid and are engageable with slots in the base 12 comprising the second locking structure 44. A steam inlet passage 84 extends through the skirt 74. When the container is coupled to the base in an inverted orientation as shown in FIG. 6, the steam inlet passage 84 is in fluid communication with the steam exit port 36. The resilient grommet forms a seal around the steam exit port and the portion of the skirt 74 surrounding the steam inlet passage as it engages the outer surfaces of the container lid 50 and the cover 126 of the steam chamber 16. The skirt may further include one or more steam vent openings (not shown). An annular gasket 85 is provided on the upper surface of the lid 50.

A perforated screen 86 is removably coupled to the container lid 50. The screen 86 is comprised of a thin, planar body portion and a centrally located dome-like depression 88. A pair of parallel walls 89 extend from the top surface of the screen and define a slot that receives the outer end of the partition wall 80 of the lid 50. The screen is thereby frictionally coupled to the lid and mostly positioned within the skirt 74 thereof.

With reference to FIG. 6, a condensate collector 90 may be positioned within the receptacle 40. The condensate collector includes a vessel 92 having a radially outwardly extending handle 94 that extends outside the base 12 through a notch 93 in the upper tier 48 when the vessel is within the receptacle 40. The bottom wall of the vessel forms a hollow center protrusion that accommodates the top end of the drive shaft 52 (FIG. 1). As shown in FIG. 6, the lid gasket 85 forms a seal between the condensate collector 90 and the lid to prevent steam from entering the condensate collector. The lid gasket forms a seal between the condensate collector 90 and the lid 50 to prevent steam from entering the portion of the receptacle 40 outside the condensate collector.

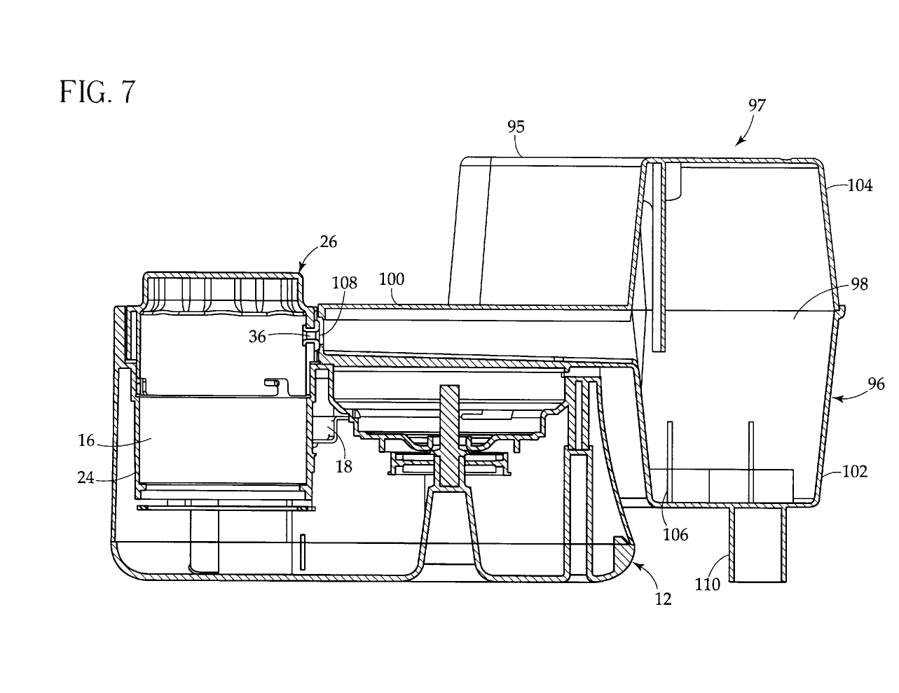

Referring now to FIG. 7, the apparatus 8 can be adapted for sterilizing baby bottles or other food containers. A sterilizing unit 97 may be provided and include a housing assembly 95 having a generally U-shaped housing 96. The housing assembly 95 includes a sterilization chamber 98 for holding a plurality of baby bottles. A housing extension 100 is connected to, and is preferably integral with the housing 96. The housing assembly includes a base unit 102 and a removable cover 104. The base unit 102 includes supports 106 for bottles that allow them to be mounted upside down. The supports further allow steam to enter the bottles. The base unit preferably includes eight supports 106, though it can be configured to hold a greater or lesser number of bottles and/or other types of food containers. The portion of the base unit 102 comprising the bottom of the housing extension 100 includes a steam inlet port 108 that adjoins the steam exit port 36 when mounted to the base 12. It further includes locking members (not shown) similar to those provided on the container lid 50 for securing it to the slots in the base 12 comprising the second locking structure 44 (FIG. 2). One or more legs 110 extend from the bottom wall of the base unit 102 for supporting the housing 96. When the housing assembly is coupled to the base 12 and the cover 104 is mounted to the base unit 102, steam can flow from the exit port 36 into the housing extension 100 and then into the sterilization chamber 98. One or more vents (not shown) can be provided for venting the sterilization chamber.

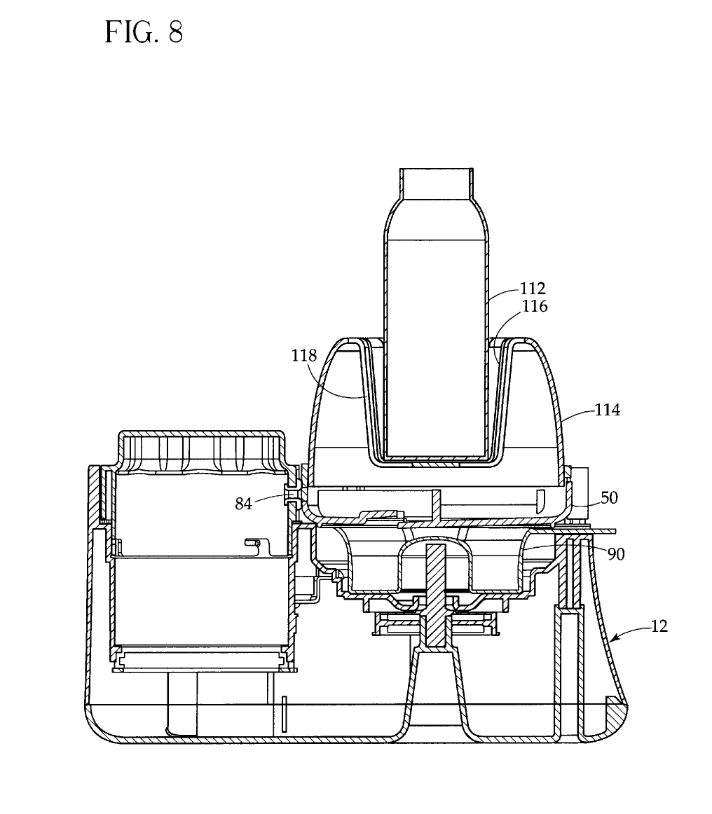

FIG. 8 shows the apparatus as configured for warming a baby bottle 112. A bottle holder 114 is provided that includes a first open end to which the lid 50 can be secured. The opposite end of the bottle holder is configured as a receptacle 116 for the bottle. The receptacle is bounded by a generally conical side wall of the holder 114 as well as a bottom wall. Both the side wall and the bottom wall include openings 118 that allow steam to enter the receptacle and thereby provide heat to the bottle contained partially therein. The bottle holder 114 and associated lid 50 are mounted to the base in the same manner as the container 14 is mounted thereto. Steam enters the bottle holder through the steam inlet passage 84 in the lid 50 and travels upwardly through the openings 118 into the receptacle 116 where it heats the bottom portion of the bottle. The condensate collector 90 is preferably employed during the bottle warming process to collect the water formed as the steam condenses about the bottle or the inner surfaces of the holder 114.

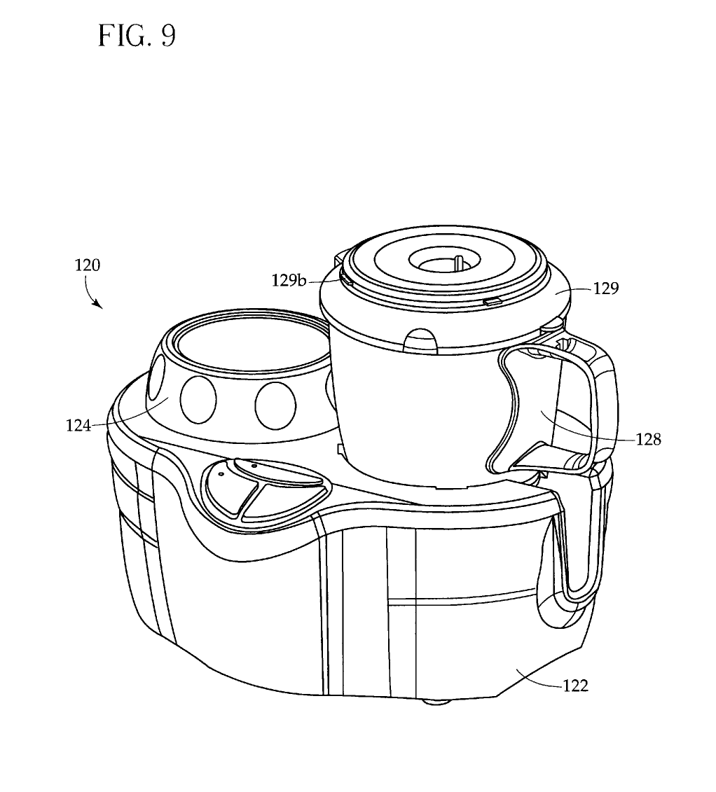

An alternative preferred embodiment of the present invention is shown in FIGS. 9 to 16. The baby food maker 120 of this embodiment is similar to the embodiment described above. With specific reference to FIGS. 9-11, a base 122 includes a steam chamber 124 and a receptacle 126 for receiving a removable container 128. The container 128 is selectively covered by a lid 129. The base includes a motor 130 for driving a blade assembly 132 disposed within the container 128. Container 128 may include a separate blade assembly 132 that is removable from the container to help facilitate cleaning.

The steam chamber 124 includes a vessel 134 for holding a liquid. The chamber is in communication with a heating element 136 which is capable of turning the liquid, such as water, into steam. The vessel 134 is covered by a removable cover 140 which may be secured by bayonet-type locking mechanism of the type described above. Cover 140 includes a top wall 142 and skirt 144. A steam exit port 146 may be disposed on skirt 144.

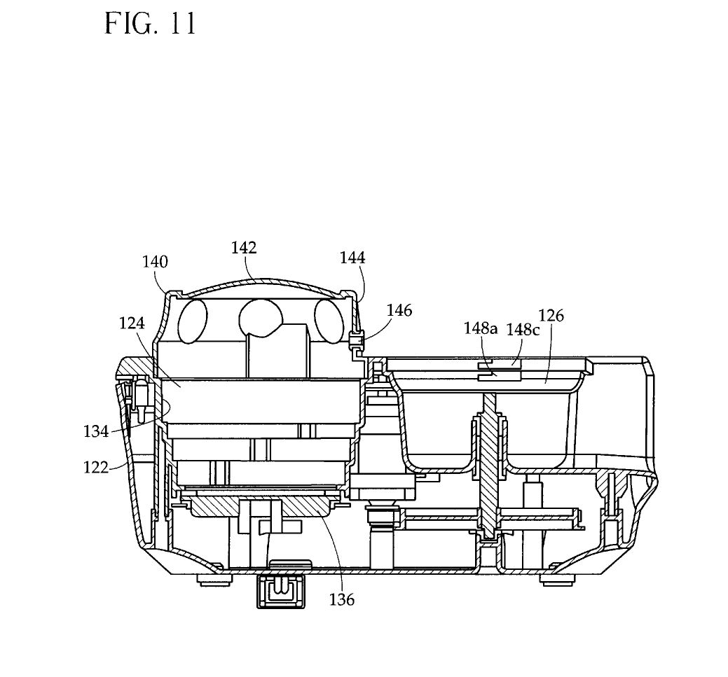

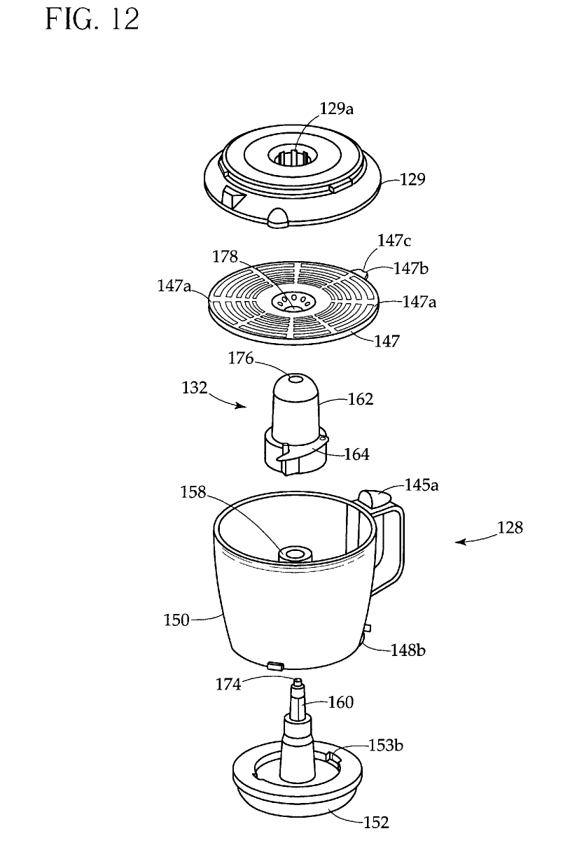

With reference to FIGS. 11 to 13, removable container 128, assembled with the lid 129 and blade assembly 132, may be placed within the base receptacle 126 in a first orientation such that the container 128 may perform as a blender for chopping and pureeing foods. The container 128 may be removably secured to the base receptacle by way of complementary locking structures 148a on the base (FIG. 11) and 148b on the container (FIG. 12) as described above with respect to the embodiment shown in FIG. 5. Alternatively, the container 128 may be placed on base 122 in a second orientation, inverted with respect to the first orientation, such that lid 129 sits in receptacle 126. In the second orientation, the contents of the container may be steamed.

Lid 129 may be removably attached to a screen 147 similar to screen 86 as described above. The manner of securement of the screen to the lid may differ from that of the previously described embodiment in that screen 147 may be held in place by way of engagement of the screen perimeter with the inside of lid skirt 149. The engagement may be secured by outwardly projecting tabs 147a (FIG. 12) disposed on the screen 147 which interlock with indentations (not shown) formed on the inner surface of the lid's skirt 149. Screen 147 may be easily removed from lid 129 to facilitate cleaning.

Lid 129 may be secured to the container 128 by way of interlocking structures, such as a bayonet-type connector as in the previously described embodiment, in which the lid is rotated with respect to the container to secure the lid to the container. A latching mechanism 145 may be provided to selectively lock the lid to the container. Preferably, the latching mechanism 145 includes a latch 145a pivotally secured to the handle 128a of the container 128 and biased in a locking position. The biasing may be provided by a section of resilient material 145b. The latching mechanism 145 further includes a projecting member 147b extending from the screen 147. The projecting member 147b extends through a notch 149a formed in lid skirt 149 and beyond the lid skirt 149. The latch 145a includes a locking end 145c which engages the projecting member 147b when the lid is secured to the container 128. When the lid 129 is rotated to the closed position, the projecting member 147b engages the latch 145a and deflects it away from the projecting member. The projecting member 147b includes a notched portion 147c (FIG. 12) which receives the locking end 145c. Once the locking end 145c is positioned within the notch 147c, the latch 145a springs back and the lid 129 may not be rotated until the user depresses the latch 145a. The depression of the latch 145a results in the locking end 145c being moved away from the projecting member 147b and out of notch 147c, thereby permitting the lid 129 to be rotated and removed from the container 128.

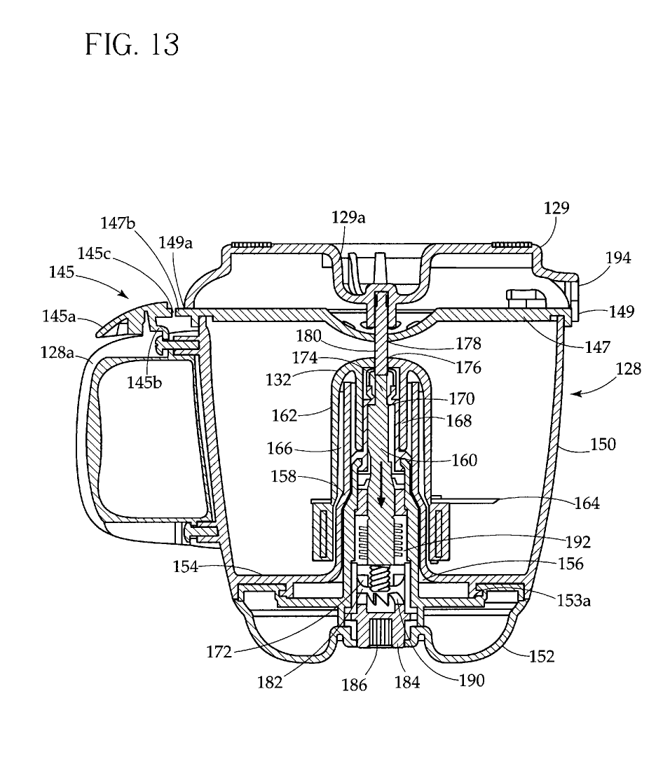

With reference to FIGS. 12 and 13, container 128 may include a housing 150 with a bottom portion 152 removably attached to the housing 150. The attachment may be achieved by way of cooperating bayonet-type connectors on the housing 153a (FIG. 13) and on the bottom portion 153b (FIG. 12) in a manner known in the art. The bottom portion 152 may be removed or attached to the housing 150 by rotating the bottom portion and housing with respect to each other. The housing 150 may include a bottom wall 154 having an opening 156, defined by upwardly extending walls 158. A drive member 160 disposed on the bottom portion 152 extends through the opening 156. The blade assembly 132 is removably securable to the drive member 160. Blade assembly 132 includes a hub 162 and blades 164 extending from the hub. Hub 162 may have an inner annular opening 166, which receives the upwardly extending walls 158. A blade assembly upper end 168 may be rotationally fixed to a drive member upper end 170 such that they will spin together. The connection between the blade assembly upper end 168 and drive member 160 permits the blade assembly to be moved axially relative to the drive member. This may be achieved by way of complimentary configurations of a type known in the art.

Drive member 160 may be operably connected to a clutch mechanism 172 which prevents the blade assembly 132 from turning when the container lid 129 is not secured to the container. The drive member 160 and clutch mechanism 172 may be disposed on the bottom portion 152. Drive member 160 is preferably longitudinally translatable with respect to the bottom portion 152. This translational movement permits the drive member and the blade assembly attached thereto to be disposed in and out of engagement with the motor 130 via the clutch mechanism 172.

In order to move the drive member, the upper end of the drive member 170 may include a post 174 that extends through an opening 176 in the top of the blade assembly 132. Screen 147 may further include an opening 178 to permit a post-like actuator 180 to extend there-through. Actuator 180 is secured to the lid and engages the blade assembly 132 when the lid 129 is properly secured on the container housing and forces the drive member 160 downwardly.

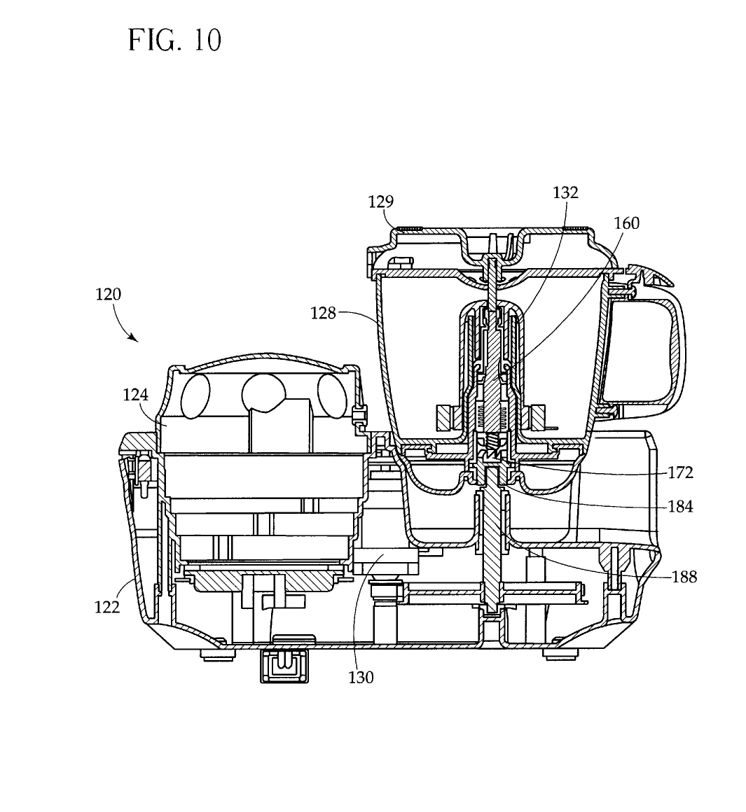

Referring additionally to FIGS. 10 and 13, the clutch mechanism 172 may include a first clutch part 182 disposed on the bottom of the drive member. The bottom portion 152 may include a coupling 184 having an opening 186 for receiving a drive shaft 188 operably connected to the motor 130. When the container 128 is secured in the base 122, the drive shaft 188 extends into the opening such that rotation of the drive shaft 188 causes the coupling 184 to rotate. An upper portion of the coupling includes a second clutch part 190. When the drive member 160 is depressed, such as when the lid 129 is secured on the container 128, the first and second clutch parts 182 and 190 engage each other. This causes the drive member 160 and drive shaft 188 to be coupled together. Therefore, rotation of the drive shaft causes the drive member and the blade assembly 132 attached thereto to rotate. In the preferred embodiment, the first and second clutch parts are toothed structures. However, it is within the contemplation of the present invention that other power transferring configurations could be employed.

The drive member 160 is preferably biased upwardly by a spring 192. When the lid 129 is removed from the container 128, the first clutch part 182 moves out of engagement with the second clutch part 190. Therefore, rotation of the drive shaft 188 and the second clutch part 190 does not cause rotation of the blade assembly 132. Accordingly, the lid 129 preferably needs to be secured to the housing 150 in order for the blades 164 to spin.

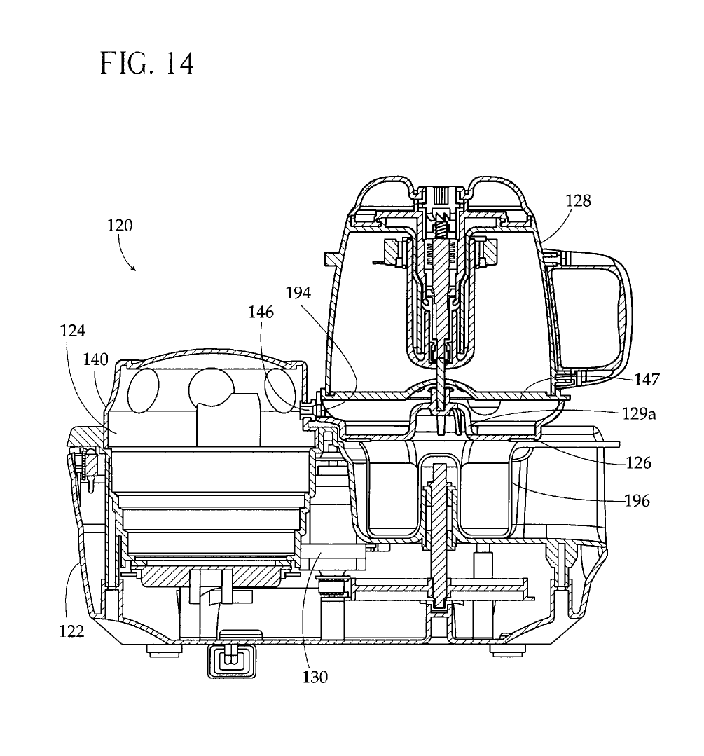

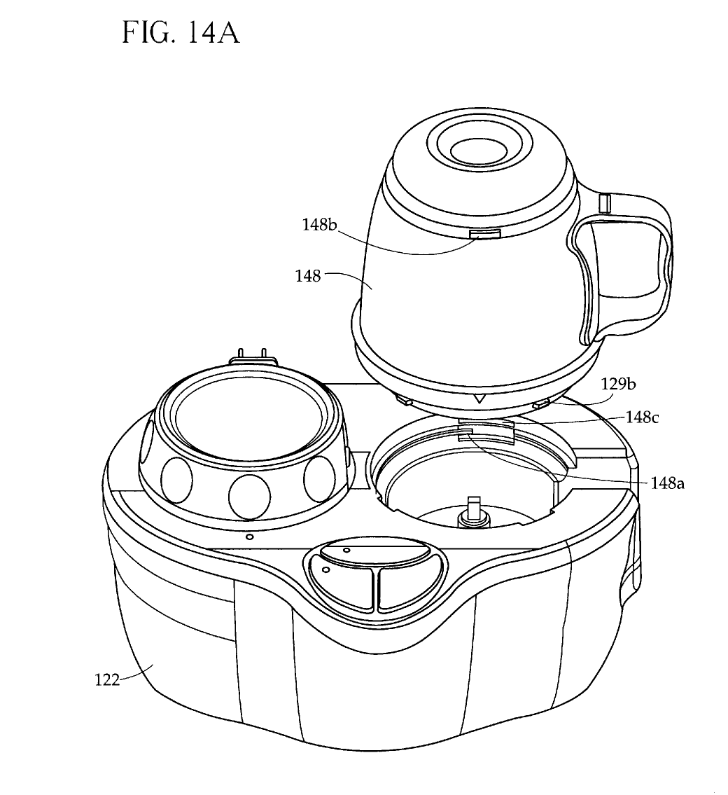

With reference to FIGS. 14 and 14A, container 128 may be secured to base 122 in an inverted orientation such that the lid 129 is positioned within the base receptacle 126. The container may be securely held in place by the cooperation of a plurality of radially extending tabs 129b formed on the lid with corresponding locking structures 148c in the base. In this orientation, the steam exit port 146 is in fluid communication with a steam inlet passage 194 leading to the inside of the container 128. Food supported by the screen 147 can be steamed as described above. A condensate collector 196, of a type as described above, may be placed within the receptacle of the base 126 to collect fluid that has condensed and exited out of the vents 129a in the lid 129.

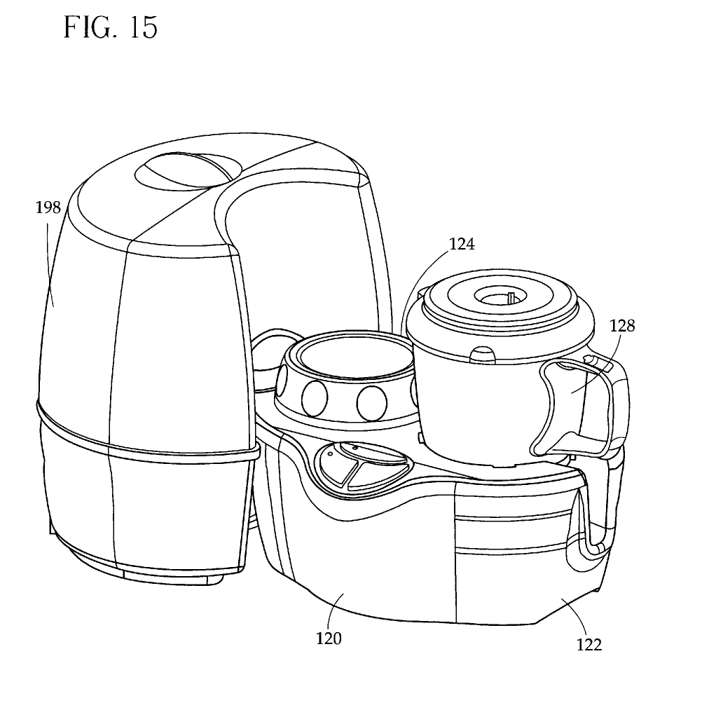

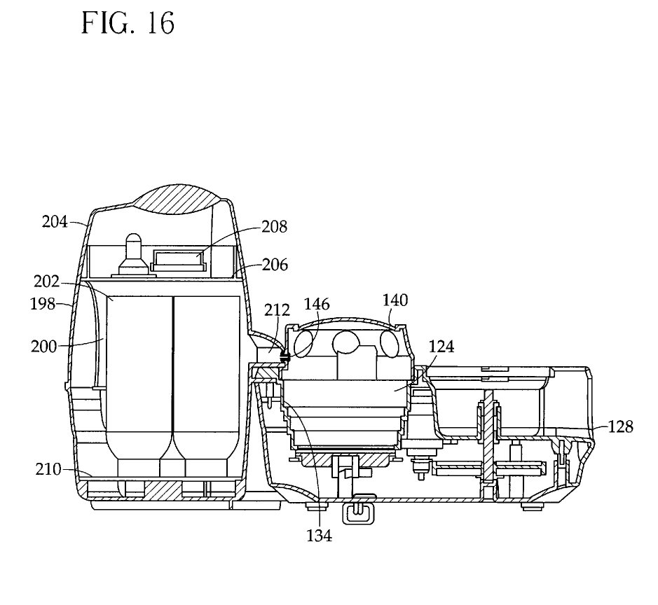

With reference to FIGS. 15 and 16, the preferred embodiment may accommodate a sterilizing unit 198 removably mountable to base 122. Sterilizing unit 198 may include a chamber 200 for accommodating a plurality of baby bottles 202. The sterilizing unit may include a removable portion 204 to permit access to the chamber. The chamber 200 may include a rack 206 for supporting bottle caps and/or nipples 208 so they may be sterilized. The bottles may be placed upon a porous screen 210 such that condensation drains away from the bottles. In the present embodiment, the sterilizing unit 198 may be disposed on base 122 adjacent the steam chamber 124. The steam chamber 124 is preferably disposed between the sterilizing unit 198 and the base receptacle 126. In addition, the presently described embodiment may also accommodate a bottle warmer in a manner as described above with respect to FIG. 8.

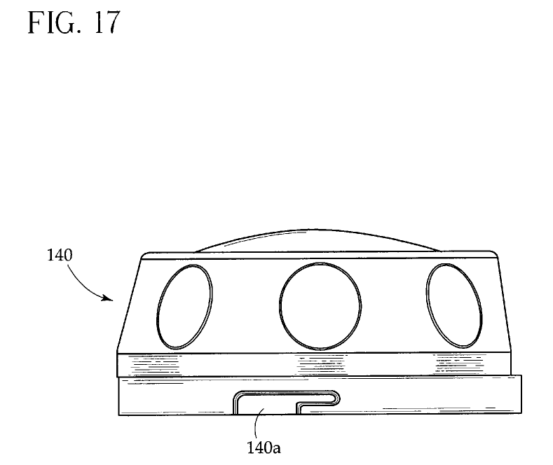

Steam may be selectively communicated to the sterilizing unit 198 and container 128 positioned in receptacle 126 by selective positioning of the steam exit port 146. To achieve this, the cover 140 of the steam chamber is preferably securable on the vessel 134 in a first and second position. In the first position, shown in FIG. 14, the steam exit port 146 is in communication with the inlet passage 194 of container 128 and the steam may be used for steaming the food held in the container 128. In a second position, shown in FIG. 16, the steam exit port 146 is in communication with a steam inlet port 212 of the sterilizing unit 198. Steam may then enter the sterilization chamber 200 and sterilize its contents. The ability to secure the cover 140 in two positions may be achieved by way of bayonet-type locking mechanism as shown in FIG. 17. The cover 140 may include a pair of generally L-shaped slots 140a diametrically disposed thereon. The slots 140a each receive one of a pair of tabs (not shown) extending outwardly from opposite sides of the steam vessel wall. When the cover is rotated the tabs engage the slots 140a thereby securing the cover 140. When the steam is desired to communicate with the container 128, a user may orient the cover 140 such that when it is tightened, the steam exit port 146 aligns with the container 128, as shown in FIG. 14. Alternatively, when the steam is desired to communicate with the sterilizing unit 198, a user would orient the cover 140 such that when it is tightened, the steam exit port 146 would align with steam inlet port 212 on the sterilizing unit 198, as shown in FIG. 16. In this embodiment, the steam is directly provided to the container, bottle warmer, or sterilizing unit, and it does not have to travel through any tubing or along any significant distance.

The operation of the baby food maker in each of the above described preferred embodiments is similar. The operation will now be described with reference to the embodiment set forth in FIGS. 1 to 8, and distinctions between the operation of this embodiment and the alternative preferred embodiment shown in FIGS. 9 to 17 will be noted. The preparation of baby food is begun by cutting uncooked food into pieces of appropriate size. The screen 86 is mounted to the lid 50 and the food is placed in the container 14. The container and lid forming a container assembly. In the alternative preferred embodiment, the blade assembly 132 is positioned in the container on the drive member 160. No further handling of the food is necessary until after it is cooked and ready to be served. The lid 50 is then coupled to the container 14. In the alternative preferred embodiment, the act of securing the lid onto the container causes the drive member 160 to be urged downwardly and the first 182 and second 190 clutch parts to be rotatably locked together as shown in FIG. 13. The condensate collector 90 is positioned in the base receptacle 40 as shown in FIG. 6. The steam chamber vessel 24 is filled with an appropriate amount of water and the cover 26 of the steam chamber is secured thereto as shown in FIG. 6. In the alternative preferred embodiment, the cover 140 of the steam chamber is secured so that the steam exit port 146 is in communication with the steam inlet port 194 of the container 128.

With reference to FIGS. 2 and 6, the container 14 and lid 50 are then mounted to the base 12 such that the lid 50 is supported by the upper tier 48 and the annular gasket 85 forms a seal between the lid and the condensate collector 90. The container and lid are locked to the base by the complementary locking elements 82, 44 on the lid and base, respectively. When locked to the base, the steam exit port 36 is in fluid communication with the steam inlet passage 84. Electrical power is provided to the heater 22, causing the water in the vessel 24 to boil and steam to be generated in the steam chamber 16. The steam exits the steam chamber through the steam exit port 36 and enters the container 14 through the steam inlet passage 84 in the lid 50. The steam travels upwardly through the screen 86, thereby cooking the food. As the steam condenses, it returns to liquid form and drips through the screen 86 and onto the inner surface of the lid 50. Because this surface is inclined in the direction of the slotted opening 76, the condensate flows towards the opening and into the condensate collector. The apparatus may be provided with a timer (not shown) for setting the cooking time. It may also include a circuit (not shown) for terminating power to the heater 22 when the vessel no longer contains water or the water level is below a preset minimum.

Once the food is cooked, the container is removed from the base 12 and the condensate collector 90 is removed from the receptacle 40. The container 14 is placed on the base in the position shown in FIG. 5 such that its base portion 68 rests on the bottom tier 46 of the receptacle 40 and the projections 70 enter the bayonet-type slots of the first locking structure 42. The container is rotated to lock it in position on the base 12. Electrical power is supplied to the motor 18, causing the blade assembly 20 to rotate and blend the contents of the container 14. The blade assembly can be operated at a single speed or multiple speeds, as known in the blender art. Condensate from the collector 90 can be added to the container through the slotted opening 76 in the lid. Once the blending process is complete, the container assembly is removed from the base 12 and the contents removed for consumption or storage. The present invention permits the food to be chopped/pureed or blended and steamed without the food being touched by the user. It is also within the contemplation of the present invention that the container 14 with its food contents may be placed within the base to permit the food to be chopped and then placed in an inverted position in the base so that the food may be steam cooked.

In order to operate the sterilizing unit, in the embodiment shown in FIG. 7, the sterilizing unit 97 is mounted on base 12 such that the base receptacle 40 is disposed between the sterilization unit 97 and the steam chamber 16. The housing extension 100 is positioned adjacent the steam chamber such that the steam exit port 36 aligns with the steam inlet port 108. The sterilizing unit's cover 104 may be removed so that bottles may be placed within the sterilization chamber 98. In the embodiment shown in FIGS. 15 and 16, the sterilization unit 198 is positioned on the base 122 adjacent to the steam chamber 124. The cover 140 may then be positioned and secured on the vessel 134 such that the steam exit port 146 is aligned with the steam inlet port 212. The heating element may then be energized to generate steam which flows into the sterilization chamber.

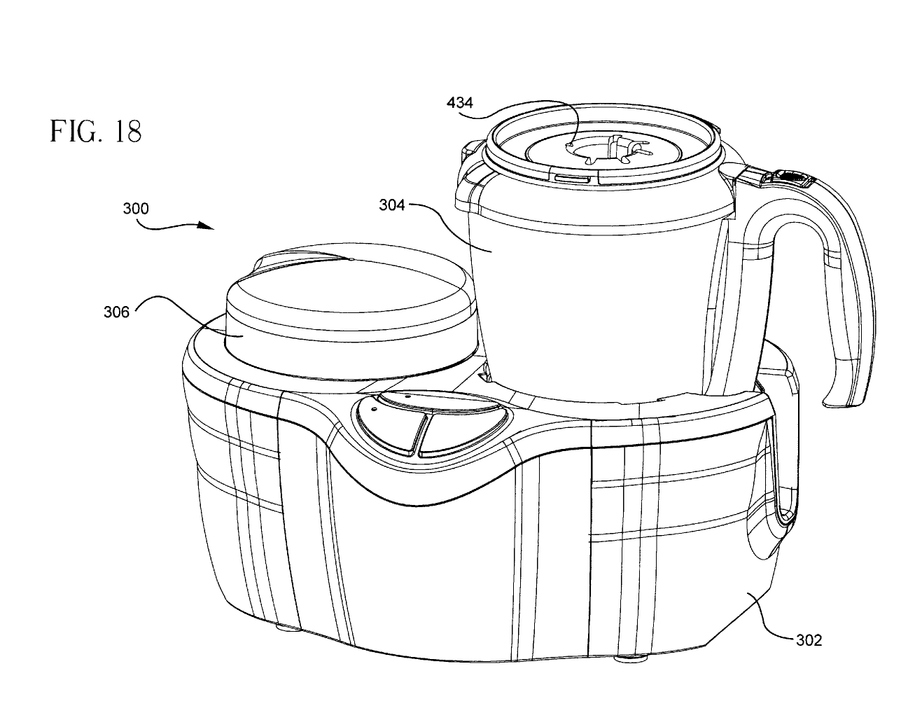

With reference to FIGS. 18-20 a further embodiment of the apparatus for steaming and blending food products is shown. As in the previously described embodiment, the apparatus 300 includes a base 302 which supports removable container assembly 304 and a steam chamber 306. A motor 308 is disposed within the base 302 and operates a blade assembly 310 which is disposed within the container assembly 304. Similar to the previously described embodiment, a user may activate the apparatus to process the food by chopping and blending using the blade assembly 310. The apparatus 300 may then be used to steam cook the food using steam generated in the steam chamber. Therefore, the food may be processed and cooked all in the same container without the user having to touch or disturb the food.

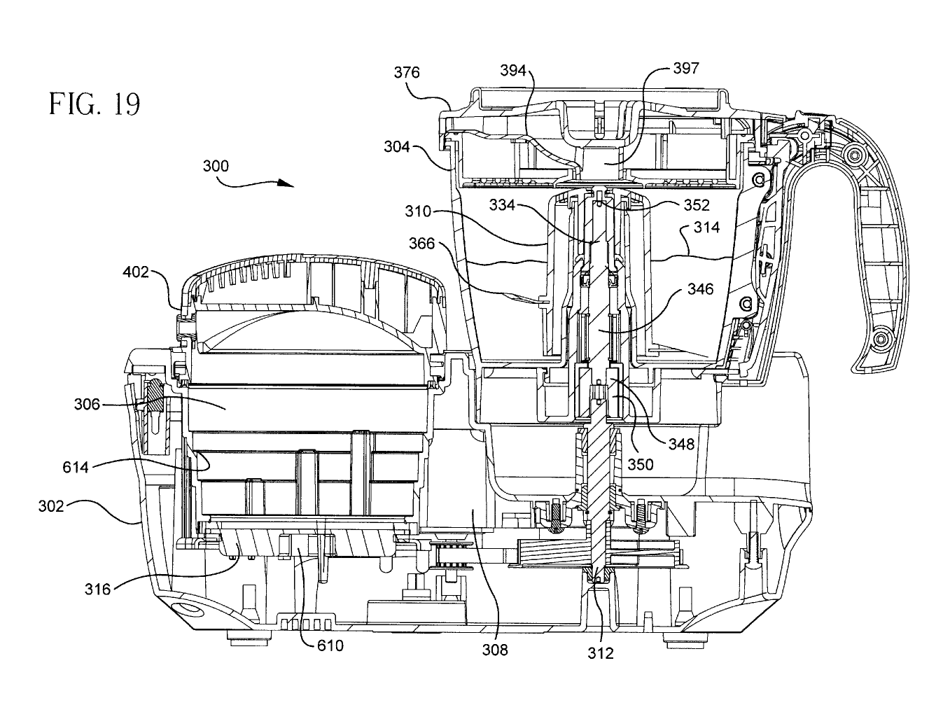

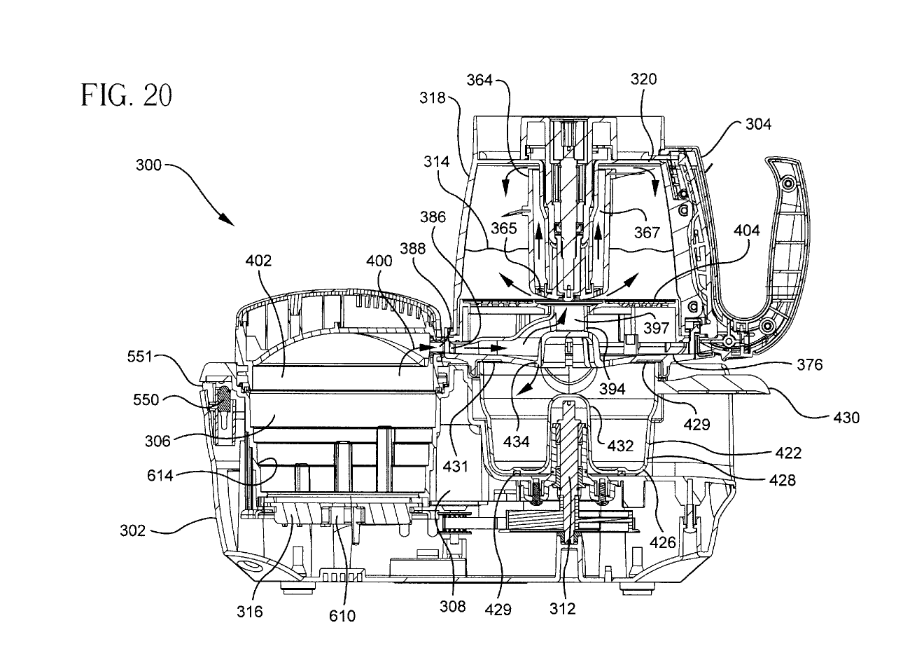

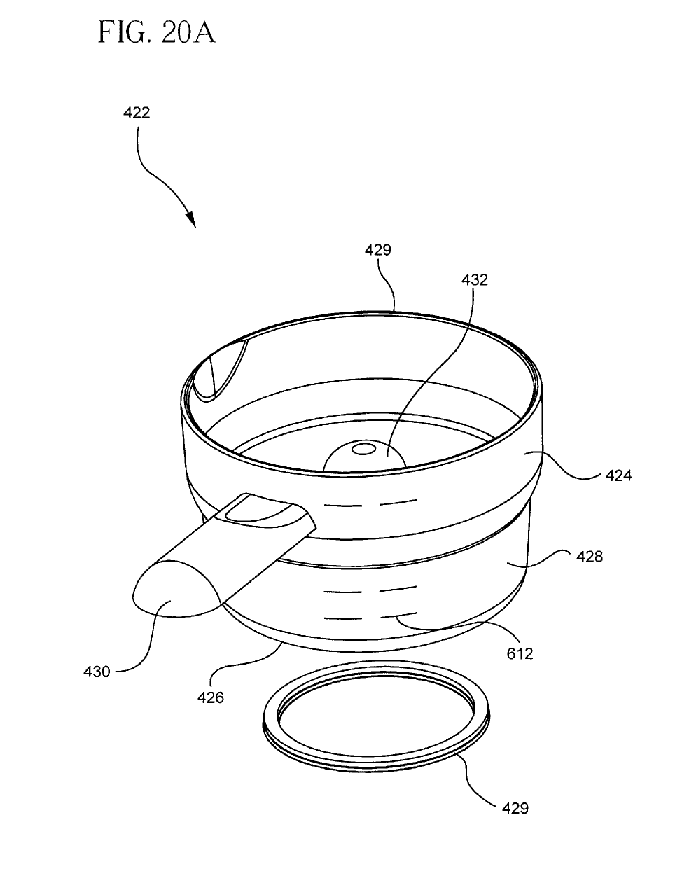

As in the previously described embodiment, the container assembly 304 may be mounted to the base 302 in a first upright position as shown in FIGS. 18-19 wherein the blade assembly 310 is in operative communication with a drive shaft 312 in the base 302. When the motor 308 is activated, the blade assembly 310 rotates such that the food 314 inside the container assembly 304 may be blended and chopped. After the food has been processed by the blade assembly 310, the container assembly 304 may be removed from the base 302 and inverted with respect to the base to a second position and reinstalled on the base as shown in FIG. 20. In this inverted second position, the steam generated in the steam chamber 306 upon energizing a heater 316 enters the container assembly 304 for cooking the food.

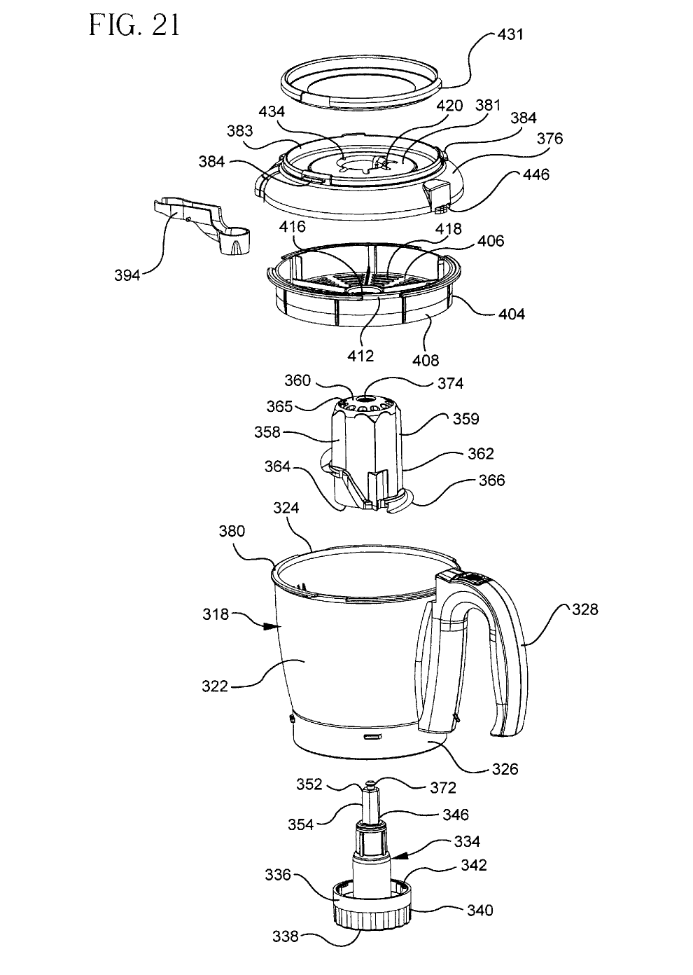

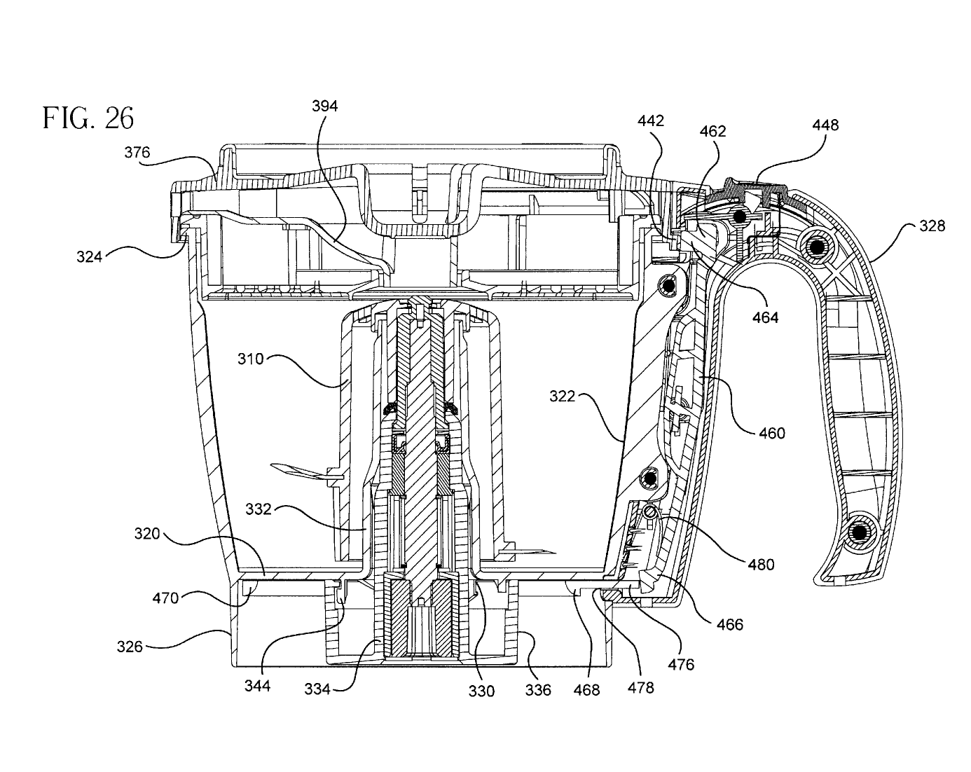

With reference to FIGS. 21 and 26, the container assembly 304 includes a container 318 having a bottom wall 320 bounded by an upwardly projecting sidewall 322 ending in a rim 324. An annular skirt 326 extends below the bottom wall 320. A handle 328 for holding the container assembly is secured to the container sidewall 322. The bottom wall 320 includes an opening 330 therein bounded by an upwardly extending housing 332 from the bottom wall. The housing 332 may have may have a generally tubular shape. The opening 330 and housing 332 receive a portion of a drive member assembly 334 which may be operably coupled to the blade assembly 310.

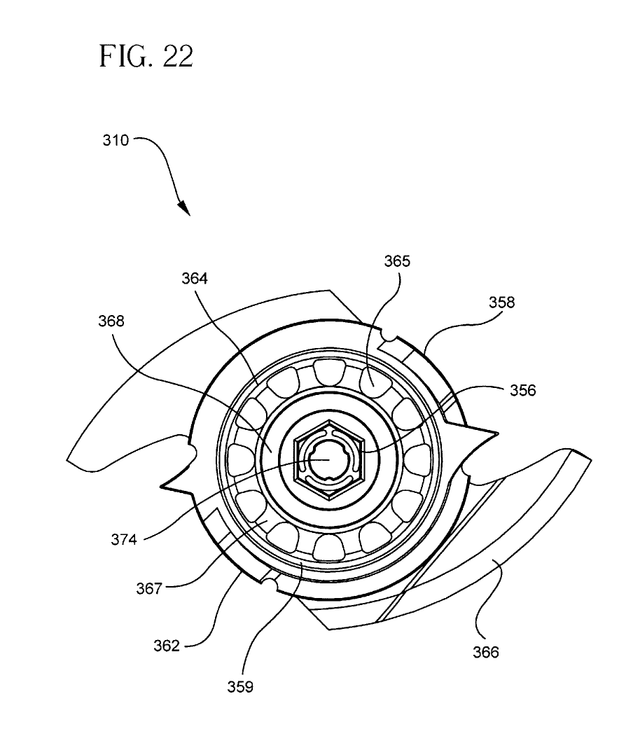

The drive member assembly 334 includes a cap-shaped base 336 having a bottom surface 338 parametrically bounded by an upwardly extending wall 340. Wall 340 inner surface includes one or more projections 342 which selectively engages tabs 344 extending from the under surface of the container bottom wall 320 when the base is rotated relative to the container. The drive member base 336 is thereby selectively lockable and unlockable to the container 304. With additional reference to FIGS. 19 and 22, the drive member assembly 334 further includes a rotatable drive member 346 having a first end 348 including a fitting 350 for coupling the to the drive shaft 312 in apparatus base 302 and a second end 352 which may be coupled to the blade assembly 310 disposed within the container 318. The drive member second end 352 includes a linear extent 354 having a hex-shaped cross-sectional configuration which mates with a complementary hex-shaped opening 356 (FIG. 22) in the center of the blade assembly 310. Therefore, rotation of the drive member 346 will result in rotation of the blade assembly 310.

With reference to FIGS. 21 and 22, the blade assembly 310 includes a hub 358 having a generally elongate tubular body 359 having a convex top wall 360 at one end bounded by a depending sidewall 362 that ends in a rim 364. The hub top wall 360 may include a plurality of radially spaced apertures 365 which are in communication with a substantially hollow inner chamber 367 formed by the hub body 359. A pair of cutting blades 366 is fixedly secured to, and extends radially outwardly from the sidewall 362. Depending from the inside surface of the top wall is the protrusion 368 having the hex-shaped internal opening 356 which mates with the drive member's hex-shaped linear extent 354. The drive member distal end 352 may include a button-like tab 372 which is inserted in a snap-fit arrangement through a central opening 374 formed in the hub top wall 360. Accordingly, a user may urge the blade assembly 310 onto the drive member 334 until the tab 372 snaps past the central opening 374, thereby removably securing the blade assembly 310 to the drive member 334. This engagement allows the blade assembly 310 to remain secured to the drive member when the container assembly 304 is inverted. The blade assembly 310 may be removed from the drive member by urging the hub 358 in an upward direction in order to allow the snap-fit engagement between the tab 372 and top wall 360 to be overcome.

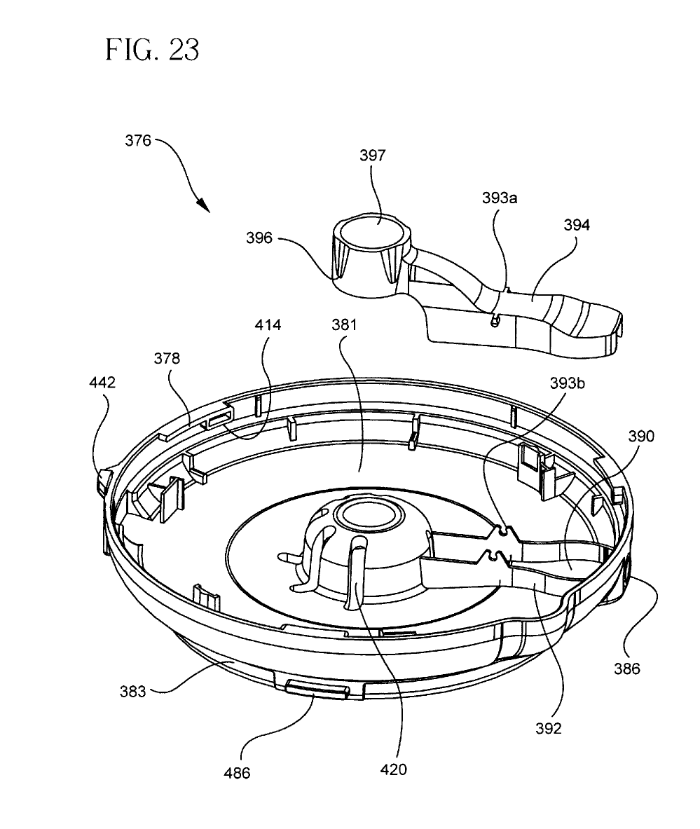

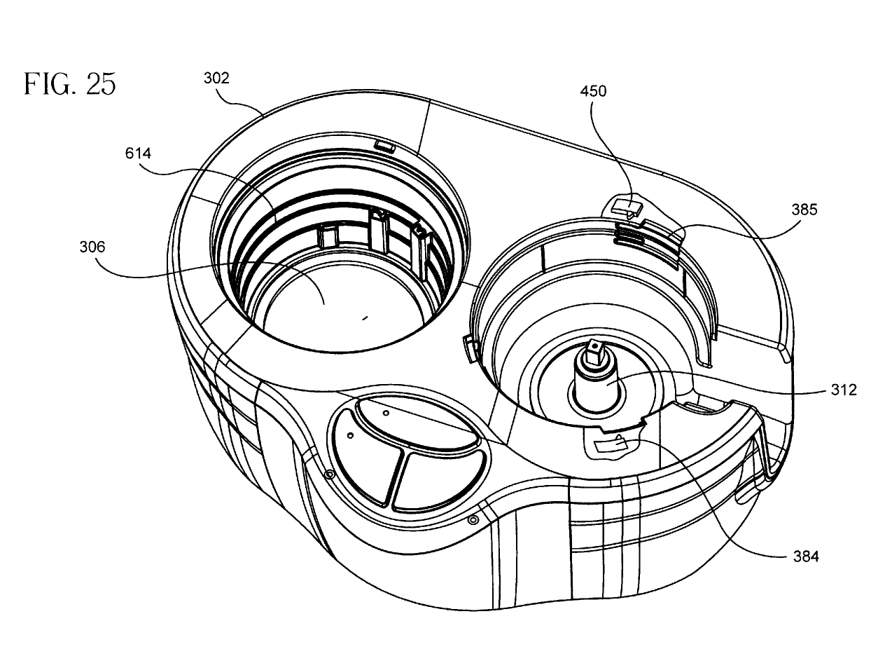

With reference to FIGS. 21 and 23, the container assembly may further include a lid 376 which is selectively securable to the container 318 by a plurality of lid locking members 378. The lid locking members 378 engage locking tabs 380 extending outwardly from the container's upper rim 324 upon rotation of the lid 376 relative to the container 318. The lid 376 may further include an annular wall 383 extending from its top surface 381. The annular wall 383 may include a plurality of projections 384 extending radially outwardly, which engage locking structures 385 (FIG. 25) in the base 302 to secure the container assembly 304 to the base in the inverted position as shown in FIG. 20.

When the container assembly 304 is in the inverted position, the lid 376 provides a passageway for the steam generated in the steam chamber 306 to enter the container 318 and engage the food therein. The lid 376 may include a steam inlet port 386 which may be brought into communication with a steam exit port 388 in the steam chamber. With reference to FIG. 23, in order to direct the steam toward the center of the lid, a steam channel 390 may be formed therein. The steam channel 390 may be formed by a pair of spaced walls 392 extending from the bottom of the lid covered by a removable elongate cover 394. Cover 394 may be secured to the lid by the snap fit engagement of complementary slots and projections 393a and 393b. The steam channel 390 is in communication with the steam inlet port 386 formed in the lid. The channel cover 394 terminates in the center of the lid and includes a ring 396 forming a central steam opening 397. The ring extends toward the hub top wall 360 such that there is a relatively small spacing between the ring and hub top wall when the lid 376 is secured to the container 318.

With reference to FIG. 20, when the container assembly 304 is inverted and secured on the base 302 in the steam cooking position, generated steam, represented by arrows 400, exits the steam exit port 388 located in the steam chamber cap 402 and travels through the steam inlet port 386 located in the container lid. The steam then travels through the lid steam channel 390 and out through the central opening 397. Some of this steam then spreads out into the container 318. This steam is directed to the food 314 adjacent the lid 376. Another portion of the steam rises through the hub apertures 365 through the hub chamber 367 and then exits out past the hub rim 364 adjacent the container bottom wall 320. The hub 358, therefore, essentially forms a conduit which functions like a chimney for directing the hot rising steam to a portion of the container above the food 314. Even if the container 318 is full of food, the hub 358 which extends axially thorough the center of the container provides an unimpeded conduit for the seam to travel along the height of the container. The steam after exiting the hub becomes dispersed throughout the container 318. Accordingly, a portion of the steam exiting the lid 376 will be dispersed toward the bottom of the food and some of it will be vented up through the hub 358 above the food such that the top portions of the food may be cooked by the steam. Thorough cooking of the food is therefore achieved.

When the container assembly 304 is inverted to facilitate the food steaming feature of the apparatus 300, the food 314 sits upon a screen 404 removably secured to the lid 376. As shown in FIG. 21, the screen may include a food support surface 406 bounded by an outwardly projecting annular sidewall 408. A lip 410 extending from the sidewall 408 may include a plurality of notches 412 for engaging locking structures 414 formed on a lower inner surface of the lid to removably secure the screen to the lid. The food support surface 406 may have a centrally located annular opening 416 to accommodate the projecting ring 396 of the steam channel. In addition, the food support surface 406 may include a number of radially spaced annular slots 418 formed therein which allow steam, condensate, and moisture removed from the food during the cooking process to pass therethrough.

With reference to FIGS. 20, 20A, and 23, the lid may include a plurality of slots 420 radially extending about a center portion of the lid. Condensed steam and cooking fluids may exit the lid through the slots into a cup-like condensate collector 422 which is inserted in the base beneath the inverted container assembly 304. With specific reference to FIGS. 20 and 20A, the condensate collector 422 may consist of a bowl-like portion 424, having a bottom wall 426 and a sidewall 428 extending upwardly therefrom and ending in a rim 429. A handle 430 may extend outwardly from the sidewall 428 in order to allow a user to easily hold the collector 422 and insert it and remove it from the base 302. The bottom wall 426 may include an upwardly extending annular protrusion 432 in order to provide clearance for the drive shaft 312 located in the base. The diameter at the upper portion of the sidewall is sized to fit closely within the lid's upward extending annular wall 383. This portion of the lid may be covered with an elastomeric material 431 (FIG. 21) such that when the container assembly 304 is placed in the inverted cooking position, the condensate collector rim 429 sits against the elastomeric material and a seal is formed between the condensate collector 422 and the container lid 376. The bottom of the condensate collector may include an elastomeric ring 429. The ring 429 allows the collector to move slightly as the ring is compressed when the container assembly 304 is secured in to the base 302. This movement compensates for dimensional tolerances and provides for a tight seal between the container lid 376 and condensate collector 422. Accordingly, steam entering the condensate collector 422 from the lid 376 will be generally maintained within the condensate collector.

It may be desirable to use the liquid collected in the condensate collector 422 for further cooking. For example, the liquid may contain nutrients drawn off from the food during the steaming process. One may want to pour the liquid back onto the food to add additional flavor and nutrients. In this case, it is desirable that the fluids be elevated to a cooking temperature above approximately 160° F. in order to kill any unwanted bacteria that may be in the liquid. In order to achieve this increase in temperature, the lid 376 may include an aperture extending through lid top surface 381 forming a lid port 434 which is in communication with the steam channel 390. When the container is inverted for the steam cooking mode, the lid port 434 will lie above the condensate collector 422 and direct steam therein. Accordingly, when subjected to the steam, which has a temperature above 212° F., the temperature of the liquid in the collector will reach a temperature above 160° F. which would be sufficient for killing unwanted bacteria.

With reference to FIGS. 23, 24 and 29, when the lid 376 is secured to the container 318, a lid lock 440 prevents the lid from being unintentionally separated from the container. This is especially important when the food is being chopped and blended by the spinning blades 366. The lid lock 440 may include a tab 442 extending from the perimeter of the lid and a biased translatable projection 444 located within the handle 328. The tab 442 may include a notch 446 formed therein such that when the lid 376 is rotated to the fully closed position, the projection 444 is urged into the notch 446. Therefore, further rotation of the lid 376 is restricted, and it is locked onto the container 318. The projection 444 may be operably connected to an actuator 448 located on the top of the handle 328 via a linkage 449. When a user slides the actuator 448 toward the container 318, the projection 444 is moved toward the handle and away from the lid and out of the tab notch 446. This then allows the lid 376 to be rotated and opened. Accordingly, removing the lid needs the use of both hands, one to move the actuator 448 and the other to rotate the lid 376, thereby preventing unwanted removal of the lid.

With reference to FIGS. 25-29, when the apparatus 300 is configured to chop and/or blend food in the container a first lockout prevents the motor 308 from being activated unless certain conditions are met. One condition may be that the container assembly 304 is properly seated in the base 302 and the other is that the lid 376 is secured and locked on the container 318. The first lockout may include a switch 450 located in the base 302. The switch 450 may be a normally open switch that prevents the drive motor 308 from being energized when the switch is un-actuated. This switch 450 will not be actuated if the container is not seated in a locked position of the base and if the lid is not secured onto the contained.

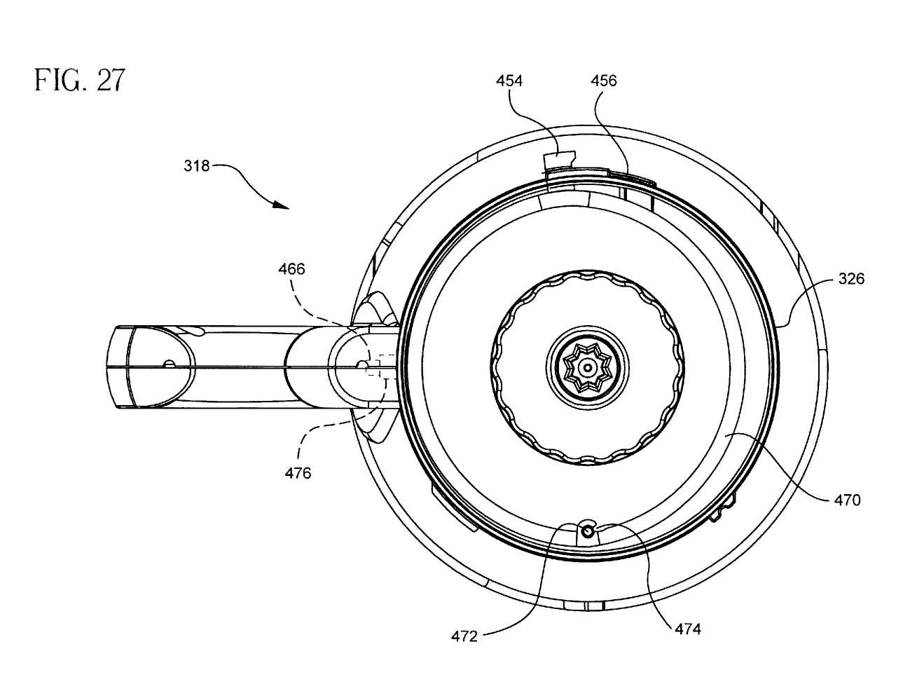

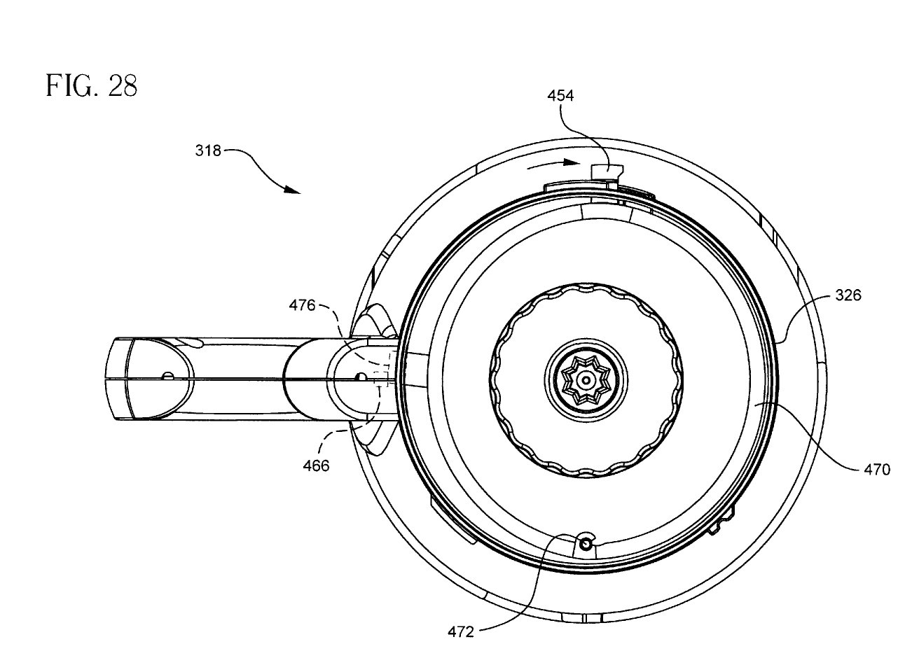

With specific reference to FIGS. 26-28, in order to actuate the lockout switch 450, the container assembly 304 includes an actuating member 454 projecting outwardly therefrom through a slot 456 in the container skirt 326. The actuating member 454 has a first position, shown in FIG. 27, in which the actuating member will not engage the switch 450 even when the container is secured to the base. The actuating member 454 has a second position shown in FIG. 28, in which the actuating member 454 will actuate the switch 450 provided that the container assembly 304 is properly seated in the base 302. The actuating member 454 is moved to the second position by the action of locking the lid 376 onto the container 318.

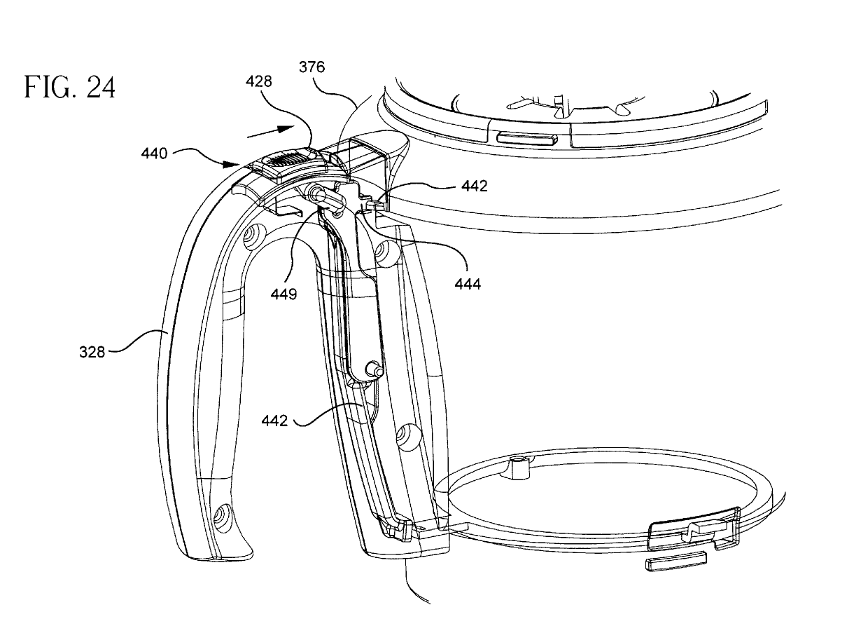

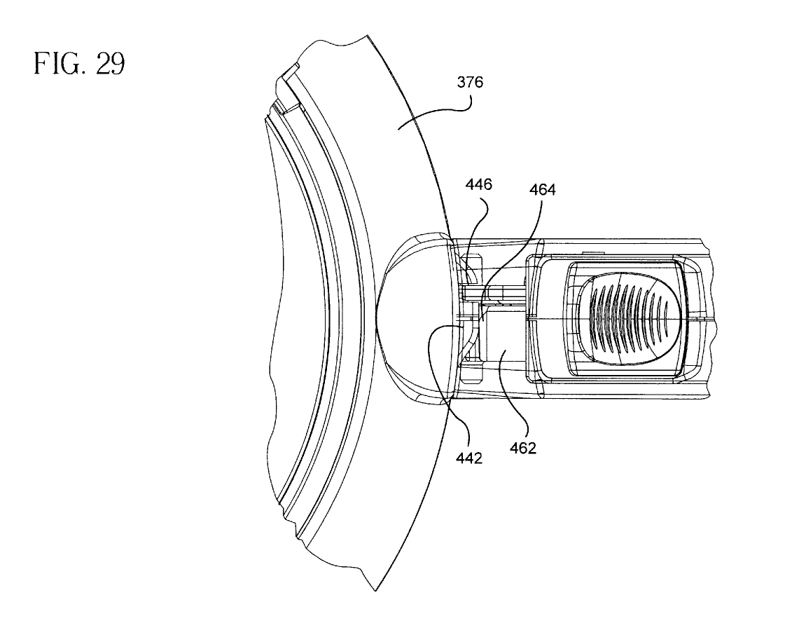

With additional reference to FIGS. 26 and 29, when the lid 376 is moved into the locked position, the lid tab 442 engages an elongate member 460 housed within the portion of the handle 328 extending along the sidewall of the container. The elongate member 460 may be disposed adjacent to the member including the projection 444 (FIG. 24) for locking the lid. The elongate member 460 may be pivotally secured to the handle generally at its middle. A lid end 462 of the elongate member may include a ramped projection 464 which is engaged by the lid tab 442 as the lid is moved to the closed and locked position. Such engagement pivots the elongate member 460 so that the elongate member lid end 462 is moved away from the lid which moves the opposite elongate member bottom end 466 the toward the container sidewall 322. The elongate member bottom end 466 then moves a lockout switch activating device 468 which in turn moves the actuating member 454 into the second position.

As shown in FIGS. 27 and 28, the actuating device 468 includes a ring 470 disposed below the container bottom wall 320. The ring 470 is pivotally secured to the bottom wall of the container. The under surface of the bottom wall may include a peg 472 extending therefrom, and the ring 470 may include an opening 474 for receiving the peg 472. Accordingly, the ring 470 can be pivoted about the peg 472. The portion of the ring adjacent the handle includes an extension 476 which extends through a slot 478 (FIG. 26), formed in the container skirt 326, and into the handle 328. The ring is pivoted when this extension 476 is acted upon by the elongate member bottom end 466 as the member is pivoted upon the locking of the lid 376 on the container 318. When the ring 470 shifts position, the actuating member 454 is moved to the second position. A biasing device 480 may act on the elongate member 460 to urge the ring 470 such that the actuating member 454 assumes the first position when the lid is not secured to the container.

In operation, upon securing the lid 376 to the container 318, the elongate member 460 is pivoted thereby urging the ring 470 to a second position against the force of biasing device 480 and the outwardly projecting actuating member 454 is moved to the second position. When the container assembly 304 is secured to the base 302 the actuating member 454 engages the switch 450. When the switch is actuated, the motor 308 driving the blade assembly 310 may be activated. Accordingly, the container assembly 304 needs to be properly positioned in the base 302 with the lid 376 secured to the container before the motor 308 can be activated.

With reference to FIGS. 23 and 25, the apparatus 300 may include a second lockout which prevents the heater 316 from being energize and steam from being generated unless the lid 376 is properly secured to the base 302, such as when the container assembly 304 is in the inverted position. The second lockout includes a switch 484 and one of the tabs 384 extending from the lid 376. When the lid 376 is placed on the base 302 and rotated to the secured position, the tab 486 activates the switch 484. The heater 316 may then be energized to generate steam.

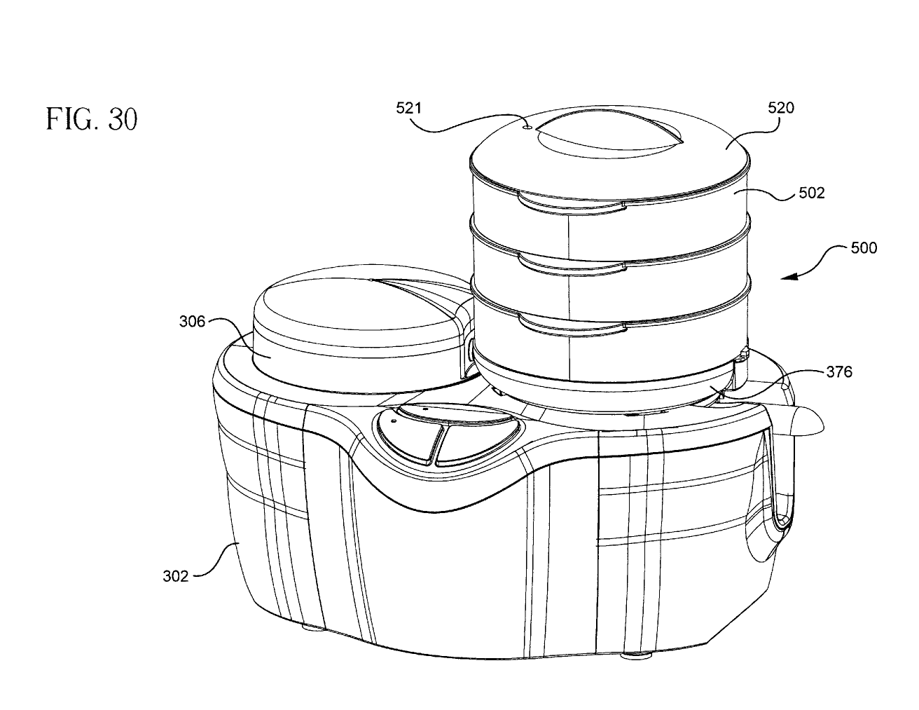

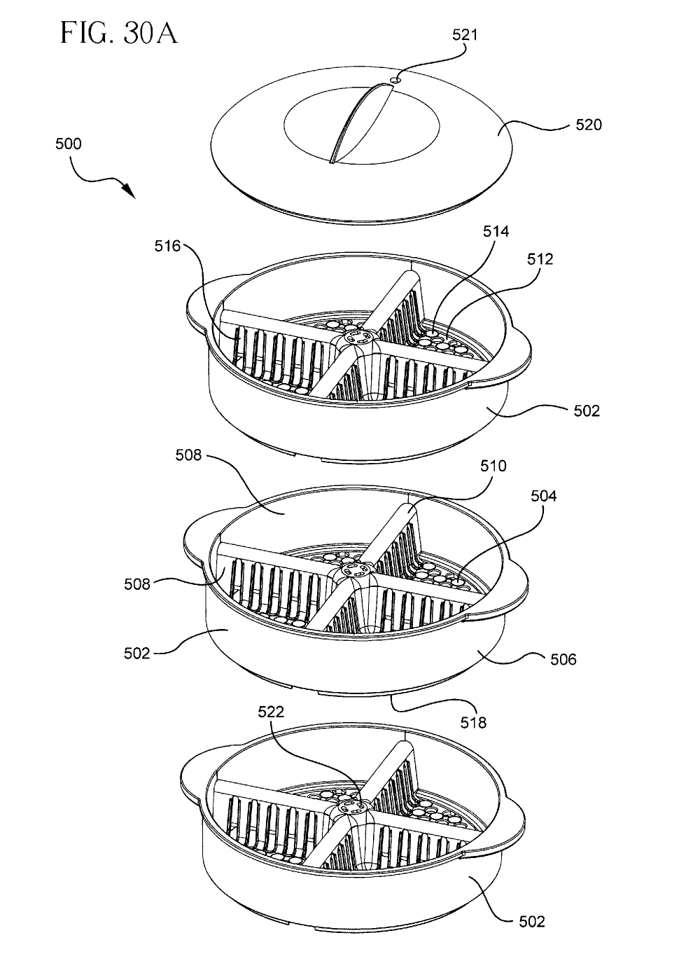

With reference to FIGS. 30 and 30A, the apparatus 300 may further provide a steam cooker 500 which allows food to be cooked upon exposure to the steam without the use of the container assembly 304. The steam cooker 500 may include a plurality of stackable trays 502 which sit within the container lid 376 in place of the screen 404. The container lid 376 may be secured to the base 302 such that the steam inlet port 386 aligns with the steam exit port 388 of the steam chamber. The undersurface of the container lid and the bottom of the trays may be sized such that the trays 502 may sit within the lid. Each of the trays may be similarly formed having a food support surface 504 surrounded by an upwardly extending sidewall 506. The support surface 504 may be divided into a plurality of food holding sections 508 by upwardly extending divider walls 510. The divider walls 510 may be formed by indentations created in the under surface of the food support surface. These indentations provide clearance for the steam channel 390 located on the underside of the lid. Each tray section 508 includes a bottom wall 512 having a plurality of holes 514 and the walls 510 dividing the sections include slots 516 such that steam may engage the food from the bottom as well as the side. In addition, dividing the tray 502, and thereby the food therein, into discrete sections prevents too much food being placed in one area thereby limiting the exposure of some of the food to the steam. Accordingly, by dividing the food into various sections the items may be thoroughly cooked upon exposure to the steam.

The bottom of the trays includes a downwardly descending rim 518 which is radially offset inwardly from the sidewall 506. The rim 518 sitting within the sidewall of the tray below it such that when stacked together they sit partially within each other to provide stability to the tray stack. A tray lid 520 may be placed over the top tray in order to keep the steam generally within the steam cooker formed by the stacked trays. The tray lid may include a vent hole 521 extending therethrough to allow steam to escape and prevent the tray lid from being lifted off the top tray by the steam. Each tray 502 may include a center portion which includes a plurality of openings 522 such that the steam in addition to passing through the holes and slots 514 and 516, the steam may also pass up through the center of the tray stack to reaches the upper trays. When using the steam cooker 500, the condensate collector may be in place such that condensed steam or cooking fluids may be collected.

When the food is placed into the trays 502 and the trays are inserted onto the lid 376 which has been secured to the base 302 as show in FIG. 30, the user may activate the apparatus 300 to begin the generation of the steam. Steam will be produced for a predetermined amount of time in order to allow the food to be cooked.

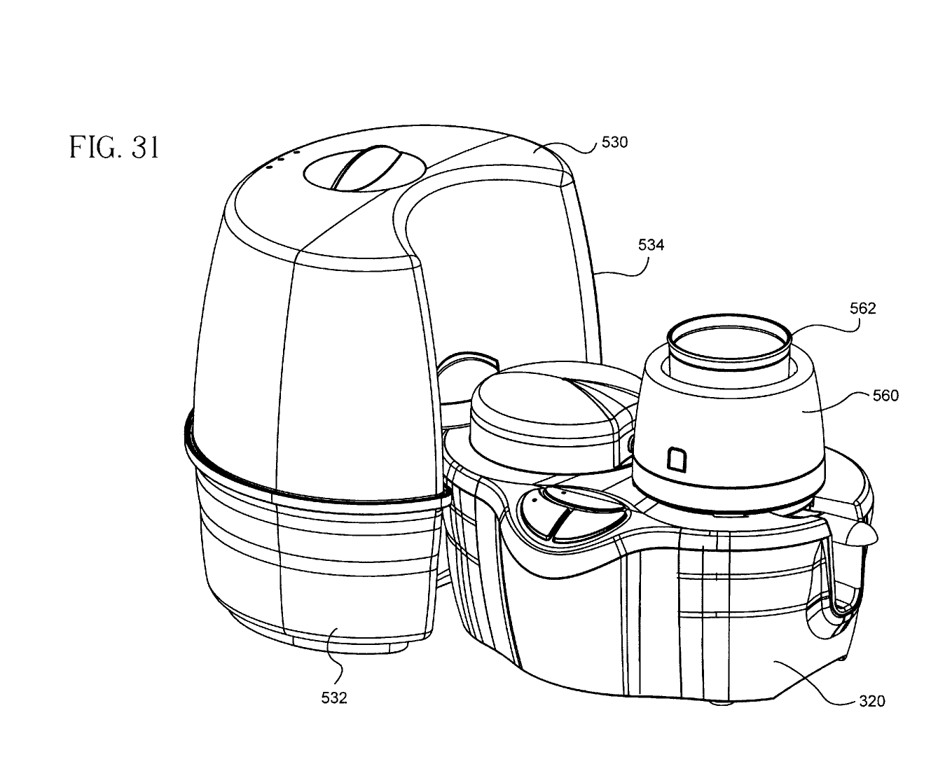

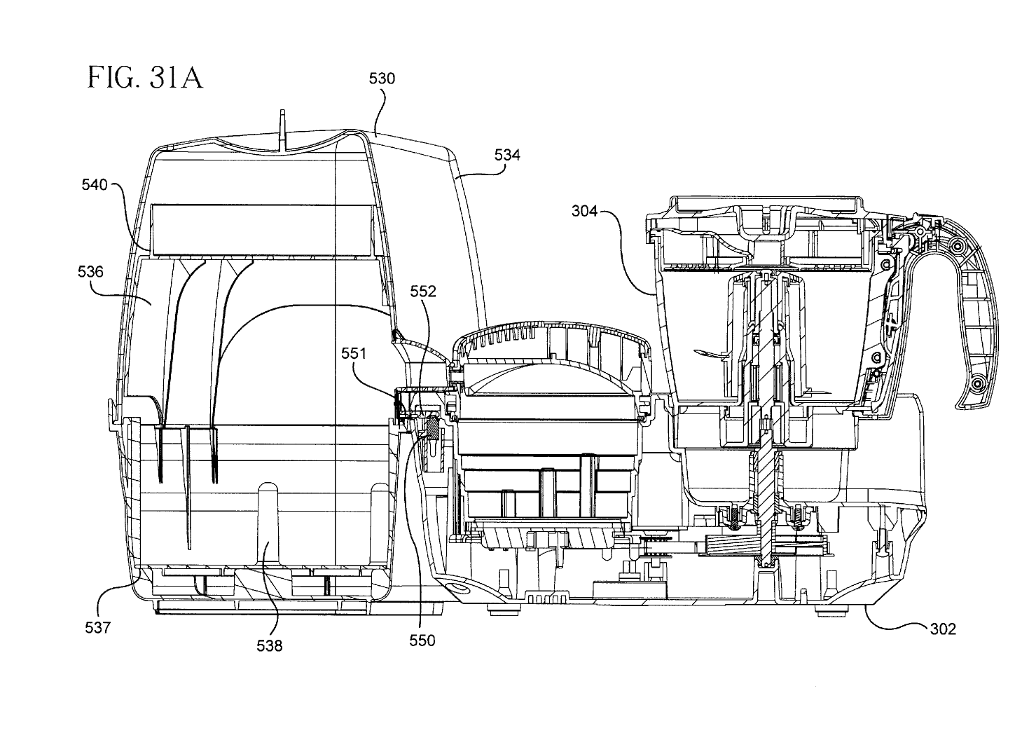

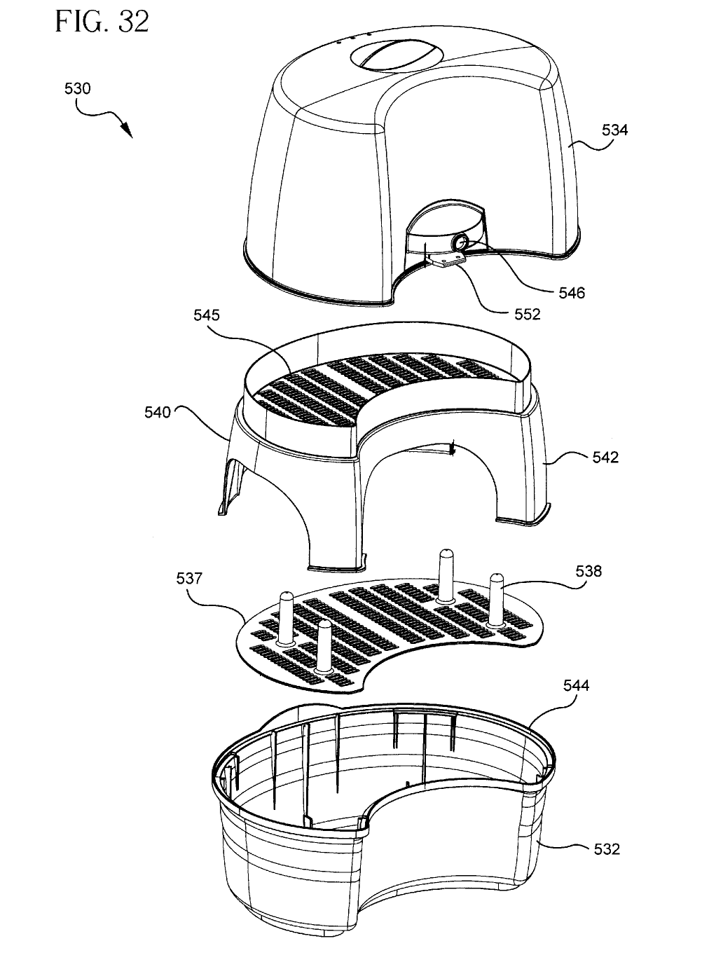

As in the previously described embodiment shown in FIG. 7, the presently described embodiment of the apparatus also includes a sterilizing unit 530 as shown in FIGS. 31 and 32. The sterilizing unit 530 allows items such as a baby bottles and related components to be sterilized through exposure to the steam. The sterilizing unit 530 may include a base 532 and a top 534 which is supportable on the base to form a substantially hollow chamber 536. A tray 537 may be placed within bottom of the base 532 and include a plurality of upwardly extending posts 538. The posts 538 may be use to support baby bottles and other containers during sterilization. A shelf 540 having four legs 542 depending therefrom is insertable in the base. The legs 542 sit on a base upper rim 544. Bottles parts, such as the caps, and other components may be placed on top of the shelf. The shelf 540 may have a plurality of openings 545 therein in order to allow the steam to circulate through the shelf surface. Steam may be introduced into the sterilizing unit through a port 546 formed in the top 534. As shown in FIG. 32, the sterilizing unit is positioned adjacent the apparatus base 302 the cover such that the steam exit port 388 is aligned with the side of the base to which the sterilizing unit is attached.

With reference to FIGS. 20 and 31A, the apparatus 300 may include a third lockout which prevents steam from being generated if the sterilizing unit 530 is not properly positioned adjacent to the base 302. The third lockout includes a third switch 550 accessible through a slot 551 in the base 302. A resilient tab 552 extending from the sterilizing unit top 534 enters the slot and engages the third switch 550 when the sterilizing unit is in an operative position adjacent the base 302 as shown in FIG. 31A. When the third switch 550 is activated the heater 316 in the base can be energized to produce steam. The tab 552 may also catch onto a portion of the base sidewall as it enters into the slot to help maintain the sterilizing unit 530 in the operative position adjacent the base.

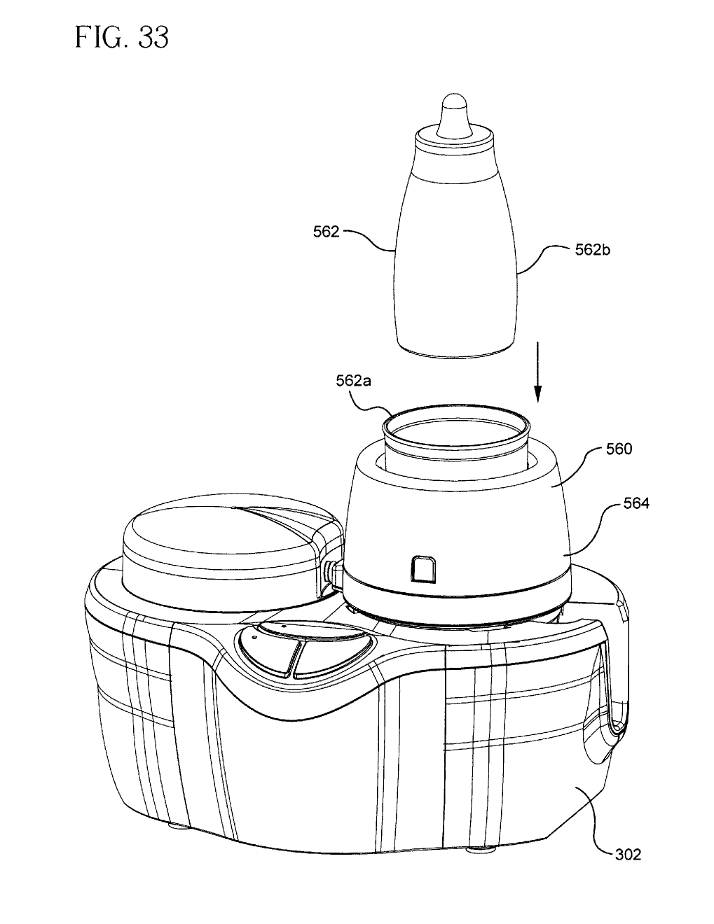

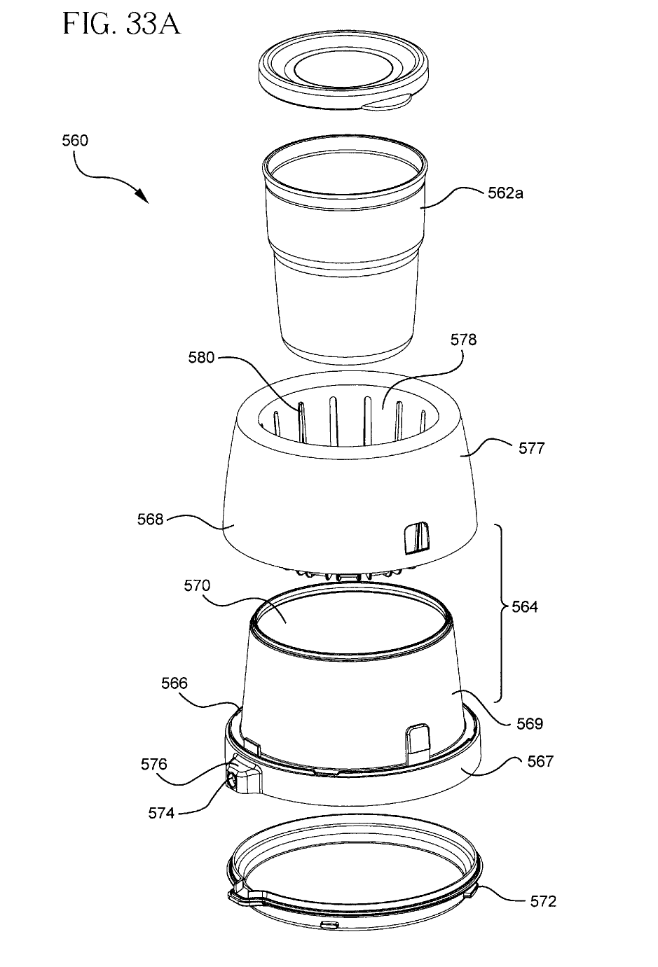

With reference to FIGS. 31, 33 and 33A, the apparatus of the present embodiment may further include a warmer 560 for warming the contents of containers 562 such as cups 562a or baby bottles 562b. The warmer 560 is operably connectable to the steam chamber to allow steam to enter the warmer and raise the temperature of containers 562 or other containers held within. The warmer 560 includes a housing 564 which is securable to the base 302 in the same location as, and in place of, the container assembly 304. The housing 564 includes a first 566 and second 568 portions which may be separated from each other to facilitate cleaning. The first housing portion 566 includes a bottom 567 and an annular wall 569 extending upwardly therefrom forming an interior space 570. A plurality of locking tabs 572 extend outwardly from the bottom and engage the base 302, such that partial rotation of the bottle warmer 560 locks it onto the base. Upon locking the bottle warmer 560 to the base 302, one of the tabs 572 engages and activates the interlock switch 484 so that when the bottle warmer is properly attached to the base, the heating element 316 may be activated to generate steam. The steam may be introduced into the bottle warmer interior space 570 by a steam port 574 formed in a protrusion 576 extending from the warmer. The steam port 574 aligns with the steam exit port 388 located on the steam chamber cover 402.

The warmer 560 second portion 568 has an outer wall 577 which fits over the first portion annular wall 569 and snaps onto the first portion 566. The second portion 568 further includes cup-shaped bottle support 578 having a plurality of slots 580 formed therein. The container 562 support sits within the interior space 570 and supports the bottle 562b or other cup 562a allowing the steam to flow beneath it and around it so that the contents of the container may be heated.

The steam chamber 306 can be used to provide steam for cooking food in the container and in the steam cooker. The steam can be used to sterilize bottles and components and to warm bottles. Accordingly, a user from time to time will have to removing the cover 402 to refill the steam chamber to use the various functions of the apparatus 300. In addition, to change from steam cooking and bottle warming to sterilizing, the steam chamber cover 402 needs to be removed and repositioned. Accordingly, the present embodiment includes a cover 402 which remains relatively cool to the touch even when steam is being generated.

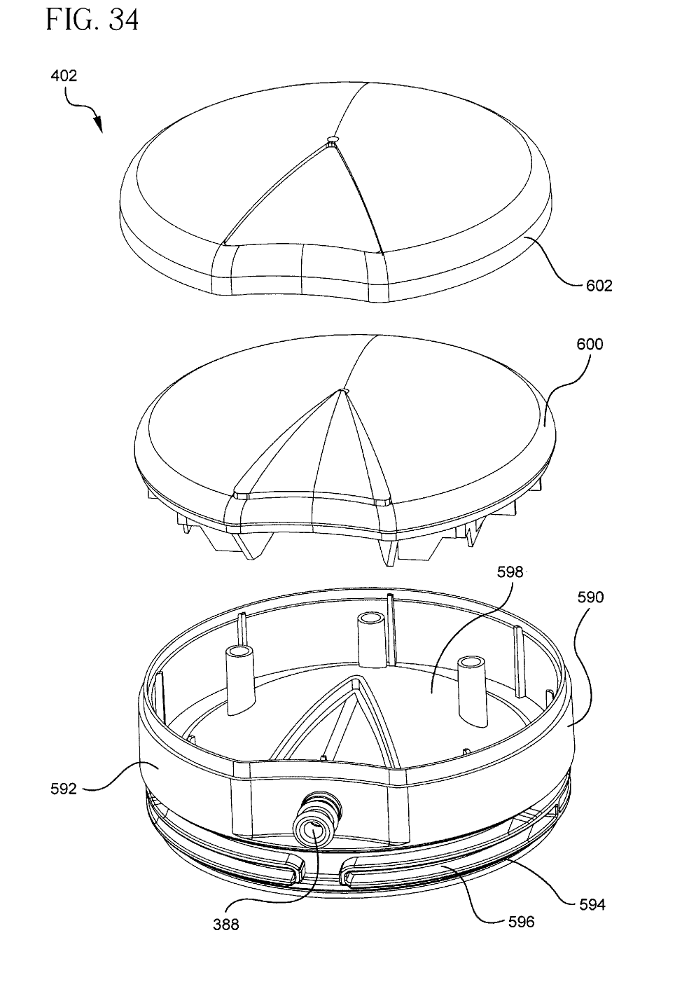

With reference to FIG. 34, the steam chamber cover 402 may be a multi-part assembly including a main body portion 590 having an outer sidewall 592 with a depending portion 594 including a plurality of grooves 596 therein. The grooves 596 receive protrusions of the base 302 to allow the cover 402 to be secured in a first position wherein the steam exit port 388 faces the container assembly 304 for steaming food, steam cooker or bottle warmer (FIGS. 20, 30 and 33) and a second position approximately 180° from the first position wherein the steam exit port communicates with the sterilizing unit 530 (FIG. 31A). The cover includes a first wall 598 having a depression therein leading to the steam exit port 388. Generated steam will rise hitting the first wall 598 and be directed out toward the steam exit port. A second wall 600 is spaced from and above the first wall 598 so that the second wall does not directly engage the steam. Therefore, its temperature remains relatively cool. A rubber or elastomeric cap 602 may extend over the second wall 600 and covers a seam between the second wall 600 and the main body portion 590. The cap 602 provides a good gripping surface for a user and further insulates the surface of the cap from the heat generated by the steam. Accordingly, the portion of the cover that the user grabs remains generally cool to the touch.

With reference to FIGS. 19, 20A and 25, the user may control the time during which the steam cooking, warming or sterilizing takes place by varying the amount of water added to the steam chamber 306. When the heater 316 is energized, steam will be produced until the water in the chamber is exhausted. The temperature of the heater 316 will then rise above a predetermined point. When this occurs, a temperature sensitive switch 610 will open interrupting power to the heater 316. In order to regulate the amount of water to place in the steam chamber 306, the condensate collector 422 may include graduated markings 612. A user may then fill the condensate collector 422 with the desired amount of water and pour it into the steam chamber 306. In addition, the steam chamber 306 may have markings 614 in the from of stepped rings therein to indicate various water levels in on order to assist the user fill the chamber to the proper level.

It will be appreciated that a variety of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus for steaming and blending food products, comprising:
a base including a support for a container assembly;
a steam chamber supported by the base and including a steam exit port;
a heater for providing heat to the steam chamber;
the container assembly including a container, a lid removably coupled to a top end portion of the container, and a steam inlet port;
the container assembly being mountable to the base in a first orientation wherein the steam inlet port is in communication with the steam exit port; and
a blade assembly rotatably disposed within the container and including an elongate hub having at least one blade extend from the hub, the hub forming a conduit for steam to travel there-through.

2. The apparatus as defined in claim 1, wherein the conduit generally extends from a bottom wall of the container to the lid.

3. The apparatus as defined in claim 2, wherein the hub includes a top wall bounded by a sidewall extending therefrom forming a substantially hollow chamber, the top surface including a plurality of apertures, and wherein the apertures and wall form the conduit extending through the hub.

4. The apparatus as defined in claim 3, wherein the lid includes the steam inlet port and the lid includes a channel extending from the steam inlet port to a position adjacent the top surface of the hub.

5. The apparatus as defined in claim 1, wherein the container assembly in the first orientation is inverted with respect to the base and the lid is secured to the base.

6. The apparatus as defined in claim 1, wherein the container is positionable on the base in a second upright orientation, wherein the container lid is spaced from the base.

7. The apparatus as defined in claim 6, wherein the blade assembly is operably connected to the drive shaft when the container assembly is poisoned on the base in the second upright orientation.

8. The apparatus as defined in claim 1, including a condensate collector removably positionable between the container and the base.

9. The apparatus as defined in claim 8, wherein the lid includes a steam opening, the opening being in fluid communication with the steam chamber, the steam opening being disposed adjacent the condensate collector to direct steam therein.

10. The apparatus as defined in claim 1, further including a lockout, the lockout preventing activation of the apparatus unless at least one predetermined condition is met, the lockout including a switch disposed on the base and an actuator movably disposed on the container.

11. The apparatus as defined in claim 10, wherein the actuator includes a ring pivotally secured to an undersurface of the container, the ring being in communication with an elongate member extending along the sidewall of the container, the elongate member having first end which is engagable with the lid when the lid is coupled to the container.

12. The apparatus as defined in claim 11, wherein the elongate member has a second end engagable with the actuator when the lid engages the first end, the second end moving the actuator to the second position and into engagement with the switch when the lid is coupled to the container.

13. The apparatus as defined in claim wherein 1, further including a steam cooker including a plurality of stackable trays, the stack of trays being positionable onto the lid in place of the container, the trays being in communication with the steam exit port.

14. The apparatus as defined in claim 13, wherein the plurality of trays include a plurality of openings therein to permit steam to pass there-through.

15. The apparatus as defined in claim 13, wherein the trays include a plurality of divided sections for retaining food therein.

16. The apparatus as defined in claim 1, wherein the steam chamber includes a removable cover, the steam exit port extending through the cover, the cover including a first wall which is in direct contact with generated steam and a second wall spaced from the first wall, the first wall preventing steam from engaging the second wall to affect the temperature of the second wall.

17. An apparatus as described in claim 1, including a housing having a steam inlet passage and containing a chamber for holding bottles, the housing being mountable to the base support such that the steam inlet passage of the housing is in fluid communication with the steam exit port.

18. A food preparation assembly comprising:
an apparatus for steaming and blending food products, comprising:
a base including a support for a container;
a steam chamber supported by the base and including a steam exit port;
a heater for providing heat to the steam chamber;
a drive shaft;
an electric motor supported by the base and operatively associated with the drive shaft;
a container assembly including a container, a steam inlet passage, and a lid removably coupled to a top end portion of the container, the container assembly being selectively mountable to the base support;
a blade assembly disposed within the container; and
a stream cooker including a plurality of stackable trays positionable on the lid of the container in place of the container, the steam cooker being selectively mountable to the base and being in fluid communication with the steam chamber.

19. The assembly as defined in claim 18, wherein the trays include a food support surface divided by walls, the food support surface and the walls including openings therein to allow steam to pass there-through.

20. The assembly as defined in claim 18, further including a warmer selectively mountable to the base, the warmer including a steam inlet passage communicable with the steam exit port and an interior chamber of the warmer, an external receptacle for receiving at least the bottom end of a container, and an opening within the warmer for allowing steam to flow from the chamber into the receptacle.

21. The assembly as defined in claim 18, further including a sterilizing unit selectively mountable to the base including a sterilization chamber, the sterilization chamber being in fluid communication with the steam exit port when mounted to the base.

22. A method for preparing food, comprising:
providing a base including a steam chamber, a steam exit port in fluid communication with the steam chamber, a drive shaft, and an electric motor for rotating the drive shaft;
providing a container assembly including a container having a bottom end portion and an open top end portion, a lid removably mounted to the top end portion, and a steam inlet passage;
providing a blade assembly disposed within the container;
introducing food into the container;
placing the container on the base in an inverted position such that the steam inlet passage communicates with the steam exit port; and
causing the steam chamber to produce steam wherein the steam enters the container through the steam inlet passage and a portion of the steam travels up through the conduit in the hub and steams the food.

23. The method as defined in claim 22 including:
removing the container assembly from the base after the food has been steamed;
replacing the container on the base in an upright position so that the drive shaft is coupled to the blade assembly; and
actuating the motor to cause rotation of the drive shaft and coupled blade assembly, thereby blending the food.
